(19) United States
(12) Patent Application Publication
(10) Pub. No.: US 2004/0238326 A1
(43) Pub. Date: Dec. 2, 2004

(54) Method and apparatus for material handling and storage

(76) Inventor: Wayne Lichti, Chester, CA (US)

Correspondence Address: RONALD ROHDE, SUITE 100, 2100 EMBARCADERO, OAKLAND, CA, 94606, US

(21) Appl. No.: 10/888,221

(22) Filed: Jul. 8, 2004

Related U.S. Application Data
(63) Continuation-in-part of application No. 10/267,497, filed on Oct. 8, 2002.

(51) Int. Cl. B65G 1/12

(52) U.S. Cl. 198/475.1; 198/347.3

(57) ABSTRACT

A material handling apparatus including two or more vertical storage towers aligned along a process path. Each of the two or more vertical storage towers includes a set of movable storage shelves coupled to define an endless loop that may be rotated bi-directionally along a vertical storage path. Each shelf may be positioned relative one or more input position associated with a horizontal input path and one or more article output position associated with a horizontal output path. One or more articles may be stored on any available shelf. Any stored article may be retrieved from any shelf, in any order, providing for random access of any article. The apparatus operates asynchronously to bi-directionally rotate each set of shelves independently of other sets of shelves and independently of the horizontal input and output paths. The material handling apparatus may be configured in modules, and may be expanded in modular increments.

### CROSS-REFERENCE TO RELATED APPLICATIONS

This invention is related to a U.S. Non-Provisional patent application Ser. No. 10/267,497 filed Oct. 8, 2002 entitled “MOVING CRANK MECHANISM” filed in the name of Robert D. Lichti and Wayne Lichti and is incorporated herein by reference thereto in its entirety.

### BACKGROUND OF THE INVENTION

1. Field of the Invention

Embodiments of the present invention generally relate to an automated apparatus and method of storing and randomly retrieving items stored.

2. Description of the Related Art

Conventional modern material handling systems provide storage and retrieval of inventoried goods, e.g. articles. Storing articles often requires delivering such articles to one or more known locations where they can be stored as inventory, for example. During a conventional inventory retrieval process, articles are retrieved from their respective storage locations, e.g., storage bins, generally in an order unrelated to their location or incoming order. Storage may be for long term, such as in a warehouse inventory system, or for short term, such as a mail sorting and distribution facility, or a mixture of long term and short term storage. Ideally, an effective materials handling system would provide the ability to both efficiently store a wide variety of goods to storage locations, track their locations, and to rapidly retrieve the items, in any desired order. Unfortunately, conventional storage systems are less than ideal in that they often are complex systems requiring large amounts of square footage, considerable amounts of operational personnel, and are generally not easily expandable without considerable effort and major changes to floor space layout, as well as existing software and hardware control systems.

For example, one type of conventional storage and retrieval system utilizes a large array of multi-level fixed storage shelves in combination with insertion and extraction or picking mechanisms, e.g., robots, that must travel to a particular shelf to place or pick the desired inventory article. An example is an automated freight terminal for sorting, staging and subsequently loading incoming or outgoing shipments in a desired sequence. Unfortunately, such a system is limited to a small number of transactions each time the extractor is operated, therefore continuous throughput is very difficult. Another limitation of such a system is that simultaneous storage, simultaneous retrieval, or simultaneous storage and retrieval of multiple articles is generally very difficult to perform. Another limitation of such a system is that adding additional shelves to increase capacity generally results in substantial increases in access time. Moreover, such a system suffers limitations in the size of the array of shelves. Consequently the capacity of the system, is determined by the range of robot movement or reach. Further, robotic equipment is generally expensive to procure and maintain and usually requires considerable amounts of reconfiguration and down time when additional storage units are added.

Another type of storage structure is a synchronous system that includes moveable multi-leveled storage carousels having a multiple number of stacks of vertically spaced trays arranged to travel horizontally about a frame. Unfortunately, such a system suffers time delays required to move all the goods at the same time, or synchronously, to position the shelves for storage or retrieval. Another major limitation of such multi-leveled storage carousels is that they are difficult to expand for additional storage capacity and if expanded cause an increase in storage and retrieval delays. Further, such multi-leveled storage carousels are single dimensional, e.g., are able to perform only one function at a time and generally cannot be used for simultaneous storage and retrieval of articles.

Another type of storage structure is a vertical tower of shelves connected in an endless loop that rotates in the vertical axis. Typically such towers are designed to rotate in one direction only, which increases storage and access time for random access. This is also a synchronous system in that all shelves move together. Many such towers are designed as “first in first out” or “last in first out” buffers between manufacturing lines or processes. Unfortunately, such “first in first out”, or “last in first out” buffers, prevent random access. Another drawback of a single vertical tower system is the limited number of storage locations. Another drawback is that the greater the number of storage locations on the tower, the longer the average access time when performing random access. Generally, systems of multiple towers are linked to rotate together, which also increases storage and access time for random access.

Thus, expansion, storage capacity, and throughput are major drawbacks with all of the above examples of material handling systems. To solve the above problems, it is likely that a manufacturer may need to install an upgrade or a complete new system which may not be economically feasible. This means that the purchasing decisions might have to project the company needs for many years in advance and buy a system that will accommodate the maximum anticipated capacity over the life of the system. This tends to increase the initial expense of such a system unnecessarily which unfortunately raises storage costs.

Therefore, what is needed is an asynchronous system for rapidly storing and retrieving articles in random order that is capable of continuous throughput, that can be configured to simultaneously store and/or retrieve multiple articles asynchronously, and that can be inexpensively expanded to accommodate increased capacity.

### SUMMARY OF THE INVENTION

An aspect of the present invention is a system configured to simultaneously receive, store, and output one or more articles. The system includes a plurality of vertical storage towers, each of the plurality of vertical storage towers having a set of movable storage locations associated therewith, each of the sets of movable storage locations being asynchronously movable relative one another along a vertical storage axis, the sets of movable storage locations defining an array of movable storage locations. The system further includes an input transportation system positioned proximate the plurality of vertical storage towers along an input axis, the input transportation system configured to receive the one or more articles thereon and position the one or more articles proximate one of the sets of movable storage locations. The system further includes an article placement system disposed proximate the input transportation system, the article placement system configured to deliver from the input transportation system the one or more articles thereon to at least one available storage location associated with at least one of the sets of movable storage locations. The system further includes an output transportation system disposed proximate the vertical storage towers, along an output axis, the output transportation system configured to receive a stored portion of the one or more articles from the sets of movable storage locations. The system further includes an article removal system positioned proximate the output transportation system, the article removal system configured to output a stored portion of the one or more articles from at least one of the sets of movable storage locations to the output transportation system. The system further includes a detection system configured to generate signals indicative of a storage status of the array of storage locations, the signals being associated with a disposition of the array of movable storage locations and the one or more articles received by the system; and a controller electrically coupled to the system and adapted to process the signals therefrom and control the disposition of the one or more articles associated with at least one of the sets of movable storage locations.

An aspect of the present invention is a system configured to process articles to be stored, the system includes two or more vertical storage towers aligned along an article processing path defined by an article input path and an article output path. Each of the two or more vertical storage towers include a plurality of storage shelving rotatably suspended between two chains that define an endless loop along a vertical storage path, each of the two or more vertical storage towers being configured to bi-directionally rotate each of the chains associated therewith to position at least some of the plurality of storage shelving proximate the article input path and article output path. The system further includes a plurality of tower controllers, each of the plurality of tower controllers being in control of at least one of the two or more vertical storage towers. Each of the plurality of tower controllers includes a memory means containing a tower control program; a processor means which, when executing the tower control program during an article storing process is configured to position along a vertical storage path one of the plurality of storage shelving associated with one of the two or more vertical storage towers proximate an article input position, and to move at least one of the articles proximate the article input position from an input transportation system to the one of the plurality of storage shelving to store the at least one article thereon. Moreover, the processor means which, when executing the tower control program during an article output process is configured to determine a stored article to be retrieved from at least one of the two or more vertical storage towers, and to rotate a storage shelving along the vertical storage path to position the stored article to be retrieved relative the article output path, and to move the stored article to be retrieved from the storage shelving to an output transportation system for disposition thereof.

An aspect of the present invention is a modular and expandable storage system configured to simultaneously and asynchronously receive, store, and output one or more articles. The storage system comprises a plurality of modules. Each module includes a set of movable storage locations disposed along a vertical axis, the set of movable storage locations being movable in the vertical axis. Each module further includes an input transportation segment disposed along a horizontal axis, proximate the set of movable storage locations, the input transportation segment being configured to receive and position the one or more articles proximate the set of movable storage locations. Each module further includes an article placement system disposed proximate the input transportation segment, the article placement system being configured to transfer from the input transportation segment, the one or more articles thereon to at least one available storage location associated with the set of movable storage locations. Each module further includes an output transportation segment disposed along the horizontal axis, proximate the set of movable storage locations, the output transportation segment being configured to receive a stored portion of the one or more articles from the set of movable storage locations. Each module further includes an article removal system disposed proximate the output transportation segment, the article removal system being configured to transfer a stored portion of the one or more articles from the set of movable storage locations to the output transportation segment. Each module further includes a detection system configured to generate one or more signals indicative of a storage status of the set of movable storage locations, the one or more signals being associated with a disposition of the set of movable storage locations and the one or more articles received by the system. In each module, the set of movable storage locations is configured to be movable asynchronously relative the input transportation segment, and the output transportation segment. Moreover, in each module, the input transportation segment is configured to receive and position the one or more articles asynchronously relative the output transportation segment. Moreover, a controller is electrically coupled to each module and adapted to process the signals therefrom and control the disposition of the one or more articles associated with the set of movable storage locations. Moreover, two or more of the plurality of modules define a two dimensional array of movable storage locations wherein each of the two or more modules operate asynchronously relative one another.

An aspect of the present invention is a method of storing and retrieving articles. The method includes determining at least one available storage location in a storage location array. The storage location array has a first storage axis and a second storage axis. The first storage axis has at least two rows of movable storage locations, the at least two rows of movable storage locations being movable along the second storage axis. The method further includes aligning at least one input transportation system along the first storage axis. The input transportation system is configured to asynchronously position at least one of the articles relative the at least two rows of movable storage locations. The method further includes determining at least one row of movable storage locations containing the at least one available storage location and positioning the at least one available storage location relative the input transportation system by asynchronously moving the at least one row of movable storage locations containing the at least one available storage location along the second axis. The method further includes receiving the at least one article on the input transportation system and positioning the at least one article asynchronously in the first axis relative the at least one row of movable storage locations having the at least one available storage location. The method further includes transferring the at least one article to the at least one available storage location. The method further includes aligning at least one output transportation system along the first storage axis. The output transportation system is configured to receive at least some articles from the at least two rows of movable storage locations and transport the at least some articles to at least one discharge position. The method further includes determining at least one article to be retrieved from any storage location having one or more of the articles stored therein, determining a row of movable storage locations containing at least one of the articles, and positioning the at least one of the articles relative the output transportation system by asynchronously moving the at least one row of movable storage locations containing the at least one of the articles along the second axis. The method further includes transferring the at least one of the articles from the row of movable storage locations to the output transportation system. The method further includes transporting the at least one of the articles on the output transportation system to the at least one discharge position.

An aspect of the present invention is a method of storing and retrieving articles. The method includes determining at least one available storage location in a storage location array, the storage location array having a first storage axis and a second storage axis, the first storage axis having at least two rows of movable storage locations, the at least two rows of movable storage locations being movable along the second storage axis. The method further includes aligning at least one input transportation system along the first storage axis, the input transportation system configured to asynchronously position at least one of the articles relative the at least two rows of movable storage locations. The method further includes determining at least one row of movable storage locations containing the at least one available storage location, and positioning the at least one available storage location relative the input transportation system by asynchronously moving the at least one row of movable storage locations containing the at least one available storage location along the second axis. The method further includes receiving the at least one article on the input transportation system and positioning the at least one article asynchronously in the first axis relative the at least one row of movable storage locations having the at least one available storage location. The method further includes transferring the at least one article to the at least one available storage location. The method further includes aligning at least one output transportation system along the first storage axis, the output transportation system configured to receive at least some articles from the at least two rows of movable storage locations and transport the at least some articles to at least one discharge position. The method further includes determining at least one article to be retrieved from any storage location having one or more of the articles stored therein. The method further includes determining a row of movable storage locations containing at least one of the articles and positioning the at least one of the articles relative the output transportation system by asynchronously moving the at least one row of movable storage locations containing the at least one of the articles along the second axis. The method further includes transferring the at least one of the articles from the row of movable storage locations to the output transportation system, and transporting the at least one of the articles on the output transportation system to the at least one discharge position.

An aspect of the invention is a method of asynchronously transporting at least one article from an input location to an output location. The method includes determining at least one available storage location from two or more independent sets of storage locations rotatably aligned along a first axis, each of the two or more independent sets of storage locations being movable along a storage axis. The method further includes aligning an input transportation system along the first axis relative the two or more independent sets of storage locations. The method further includes forming at least one article input position by asynchronously moving the at least one available storage location along the storage axis until the at least one available storage location is aligned with the input transportation system in an article receiving position. The method further includes transporting at least one of the articles asynchronously from the input location along the input transportation system and aligning the at least one of the articles proximate the at least one article input position. The method further includes inserting the at least one article into the at least one available storage location. The method further includes aligning an output transportation system along the first axis relative the two or more independent sets of storage locations. The method further includes forming at least one article output opening by asynchronously rotating the at least one storage location with an article to be extracted therefrom along the storage axis until the at least one storage location is aligned with the output transportation system in an article extraction position. The method further includes extracting the article to be extracted from the at least one storage location onto the output transportation system, and transporting the article to be extracted on the output transportation system to the output location.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the present invention may admit to other equally effective embodiments.

FIG. 1 is a perspective view of one embodiment of a vertical storage tower system in accordance with aspects of the invention.

FIG. 2 is a perspective view of one embodiment of a vertical storage tower system in accordance with aspects of the invention.

FIG. 3 is a perspective view of one embodiment of a vertical storage tower in accordance with aspects of the invention.

FIG. 4 is a plan sectional view along 4-4 of the vertical storage tower of FIG. 3 in accordance with aspects of the invention.

FIG. 5 is a fragmented perspective view of one embodiment of a vertical storage tower in accordance with aspects of the invention.

FIG. 6 is a fragmented perspective view of one embodiment of a conveyor system that may be used with an input transportation system and an output transportation system in accordance with aspects of the invention.

FIG. 7A and FIG. 7B are perspective views of one embodiment of an article positioning apparatus in accordance with aspects of the invention.

FIG. 8A is a perspective view of one embodiment of a shelf position detector in accordance with aspects of the invention.

FIG. 8B is a high level schematic of one embodiment of a shelf position feedback circuit in accordance with aspects of the invention.

FIGS. 9A through 9C is a high level view of one operational embodiment for transferring articles from an input transportation system to an available storage location within a vertical storage tower accordance with aspects of the invention.

FIGS. 10 is a high level view of one operational embodiment for storing articles within a vertical storage tower accordance with aspects of the invention.

FIGS. 11A through 11C is a high level view of one operational embodiment for moving articles from a vertical storage tower to an output transportation system in accordance with aspects of the invention.

FIG. 12 is a perspective view of a vertical storage tower controller in accordance with aspects of the invention.

FIG. 13 is a high level block diagram of a vertical storage tower controller in accordance with aspects of the invention.

FIG. 14 is a high level block diagram of a vertical storage tower host controller in accordance with aspects of the invention.

FIG. 15 is a flow diagram of a method to determine storage disposition of articles processed by a vertical storage tower system in accordance with aspects of the invention.

FIG. 16 is a flow diagram of a method to determine output disposition of articles processed by a vertical storage tower system in accordance with aspects of the invention.

### DETAILED DESCRIPTION OF THE PREFERRED EMBODIMENT

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention. Embodiments of the present invention are described in terms of wireless communication systems such as defined in IEEE 802.11, and networks such as Wireless Local Area Network (WLAN), Wireless Wide Area Networks (WWAN), and other networks utilizing data packet communication such as the Internet. However, It is understood the present invention is not limited to any particular communication system or network environment.

As will be described below, embodiments of the present invention pertain to specific method steps implementable on computer systems. In one embodiment, the invention may be implemented as a computer program-product for use with a computer system. The programs defining the functions of at least one embodiment can be provided to a computer via a variety of computer-readable media (i.e., signal-bearing medium), which include but are not limited to, (i) information permanently stored on non-writable storage media (e.g. read-only memory devices within a computer such as read only CD-ROM disks readable by a CD-ROM or DVD drive; (ii) alterable information stored on a writable storage media (e.g. floppy disks within diskette drive or hard-disk drive); or (iii) information conveyed to a computer by communications medium, such as through a computer or telephone network, including wireless communication. The latter specifically includes information conveyed via the Internet. Such signal-bearing media, when carrying computer-readable instructions that direct the functions of the invention, represent alternative embodiments of the invention. It may also be noted that portions of the product program may be developed and implemented independently, but when combined together are embodiments of the invention.

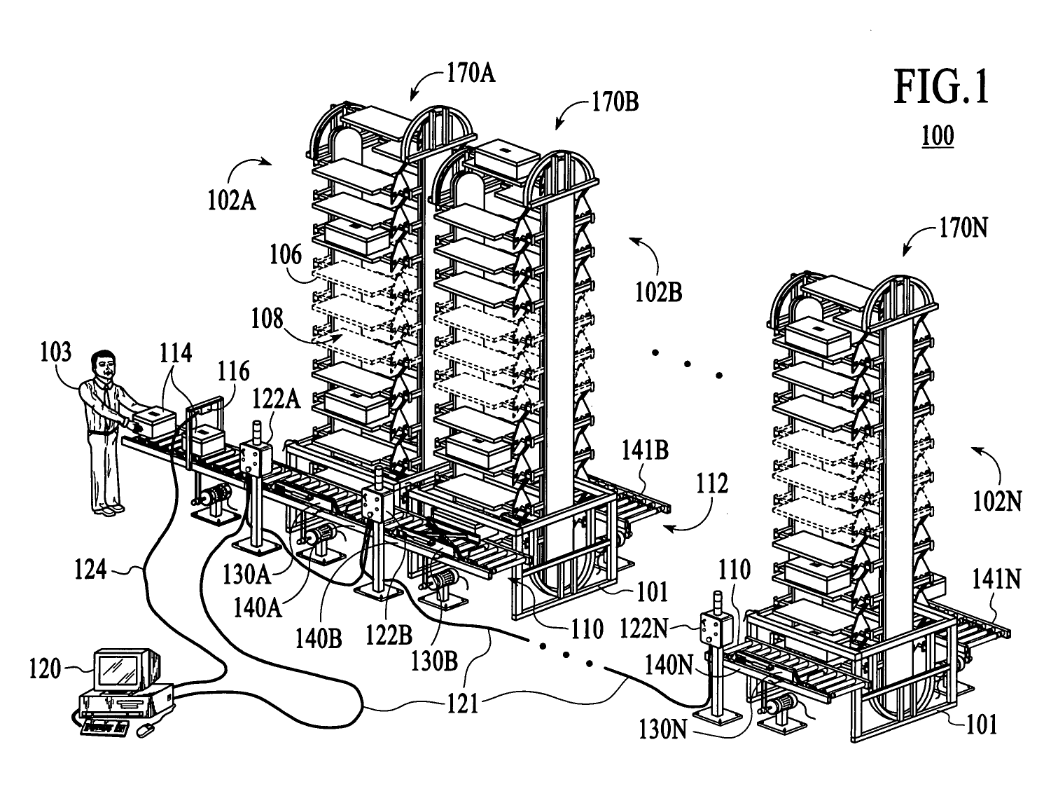

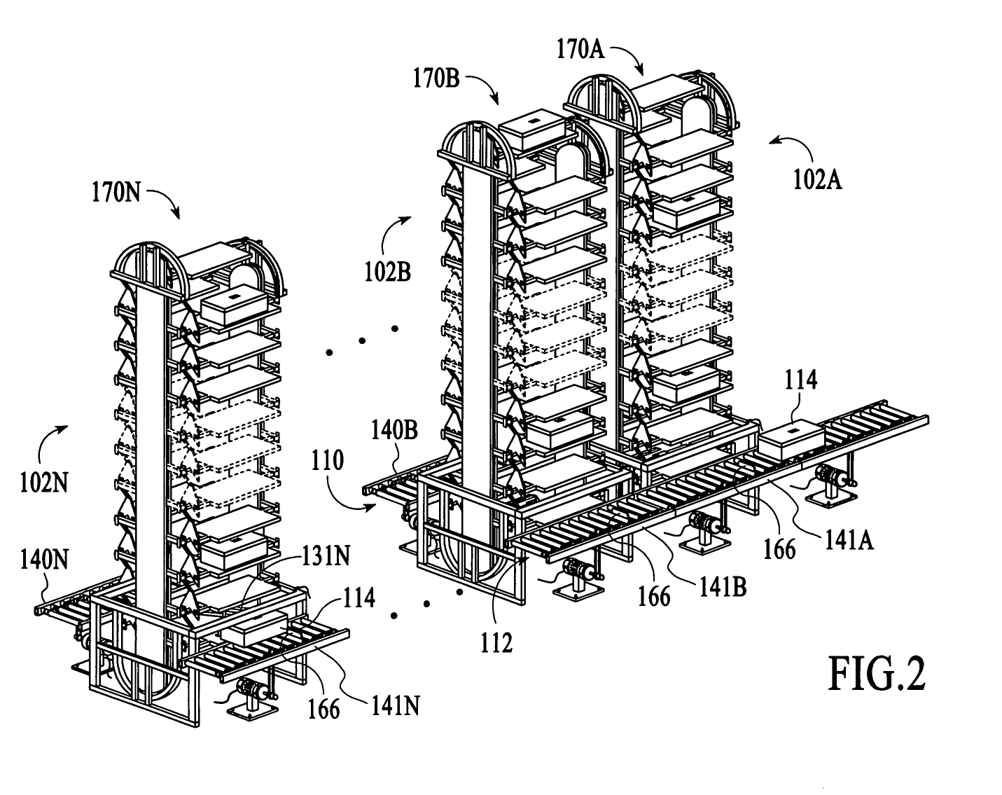

FIG. 1 and FIG. 2 are perspective views of one embodiment of a vertical storage tower system 100 in accordance with aspects of the invention. Vertical storage tower system 100 is a self-contained system having the necessary utilities supported on a mainframe structure 101 which can be easily installed and which provides a quick start up for operation. Vertical storage tower system 100 includes two or more vertical storage towers 102A through 102N, where N is defined as an “N” number, i.e., a plurality of storage towers 102A-N. For example, vertical storage tower system 100 may include two or more vertical storage towers 102A and 102B. Each vertical storage tower 102A-N includes at least two or more horizontal storage shelves 106 that define an array of vertically movable storage locations 108 for processing one or more articles 114 as described further below.

Vertical storage tower system 100 includes one or more input transportation system 110 and one or more output transportation system 112. Input transportation system 110 may be configured to receive articles 114 for storage and delivery from input systems (not shown) such as people, delivery carts, trucks, storage bins, conveyors, pallets, bins, delivery conveyors, hand carts, and the like. Input transportation system 110 is configured to transport articles 114, such as storage boxes, between input systems and vertical storage towers 102A-N. For example, one or more articles 114 may be moved along input transportation system 110 to position such articles 114 proximate one of vertical storage towers 102A-N for disposition thereon. Output transportation system 112 may be configured to receive one or more articles 114 from vertical storage towers 102A-N and transport such articles 114 between vertical storage towers 102A-N and article output systems (not shown) such as, people, delivery carts, trucks, storage bins, conveyors, pallets, bins, delivery conveyors, hand carts, and the like. For clarity, input transportation system 110 and output transportation system 112 are described herein in terms of conveyor systems, however other types of input transportation systems 110 and output transportation systems 112 are contemplated such as cart driven transportation systems, belt type transport systems, and the like. For clarity, a single input transportation system 110 is described and illustrated herein, distal a single output transportation system 112. However, input transportation system 110 may be disposed on a side common output transportation system 112, separated by a predetermined vertical distance. Moreover, it is contemplated that a plurality of input transportation systems 110 may be disposed proximate vertical storage towers 102A-N on either side or both sides, separated by a predetermined vertical distance. It is further contemplated that a plurality of output transportation systems 112 may be disposed proximate vertical storage towers 102A-N on either side or both sides, separated by a predetermined vertical distance. For clarity, input transportation system 110 and output transportation system 112 are described and illustrated as unidirectional. However, it is contemplated that input transportation system 110 and output transportation system 112 may be bi-directional.

In one embodiment, input transportation system 110 may include two or more input transportation segments 140A-N. Input transportation segments 140A-N may be disposed proximate respective vertical storage tower 102A-N. Input transportation segments 140A-N may be configured to accept articles 114 from adjacent input transportation segments 140A-N. In such configuration, for example input segments 140A-N may be aligned end to end, operationally functioning as a single input transportation system 110. In one embodiment, output transportation system 112 may include two or more output transportation segments 141A-N. Output transportation segments 141A-N may be disposed proximate respective vertical storage tower 102A-N. Output transportation segments 141A-N may be configured to accept articles 114 from adjacent output transportation segments 141A-N. In such configuration, for example output segments 141A-N may be aligned end to end, operationally functioning as a single output transportation system 112.

In one aspect of the invention, vertical storage tower system 100 further includes a host controller 120. The host controller 120 is coupled to a plurality of tower controllers (further described below) 122A-N via an input/output (I/O) cable 121. In general, host controller 120 may include a controller, such as programmable logic controller (PLC), computer, or other microprocessor-based controller described further herein. Host controller 120 may be configured to provide control signals 121 for the processing, i.e., disposition, on vertical storage towers 102A-N and movement of articles 114 along input transport system 110 and output transportation system 112. Host controller 120 may also be configured to receive and process signals 124 from, for example, an article detector system 116. Article detector system 116 may include virtually any type of detector such as a general bar code reader, infrared radio frequency (RF) bar code scanning devices configured to read barcodes, magnetic scanners, infrared motion detector, and the like configure to detect and identify articles 114 received on input transport system 110. For example, article detection and identification system may be a bar code reader positioned on mainframe structure 101 to detect articles placed on input transport system 110 by an operator 103 thereof. Host computer 120 may then associate identifying article indicia, for example a unique number or alpha numeric code, with articles 114. Identifying article indicia, such as bar codes, may be used by host computer 120 to keep track of articles 114 as such articles 114 progress through vertical storage tower system 100.

Vertical storage tower system 100 further includes at least one tower controller 122A-N. Tower controllers 122A-N may include a controller, such as PLC, computer, or other microprocessor-based controller described further herein. Tower controller 122A-N may be configured to provide one or more control signals 123 for the processing, i.e., disposition, of articles on a respective vertical storage tower 102A-N disposed adjacent thereto. For example, tower controller 122B may provide control signals 123 to vertical storage tower 102B to control the vertical position of one or more shelves 106 and therefore storage locations 108 with respect to input transport system 110 and output transportation system 112. Tower controllers 122A-N may be adapted to receive one or more input signals 124, described further herein, such as article position status, from host controller 120, and from sensing devices, described herein, that are disposed adjacent vertical storage towers 102A-N, indicative of tower status such as position, velocity, and the like. Tower controller 122A-N may also be adapted to receive input signals 124 from sensing devices positioned proximate input transport system 110 and output transportation system 112 indicative of article 114 status such as identity, position, velocity, size, weight, and the like.

In one embodiment, vertical storage tower system 100 may be configured as a set of two or more modules 170A-N. A module may include a vertical storage tower 102A-N, an input transportation segment 140A-N of an input transportation system 110, an output transportation segment 141A-N of an output transportation system 112, a tower controller 122A-N, an article placement system 130A-N, and an article output apparatus 131A-N. Input transportation segment 140A-N may be disposed to receive articles 114 from adjacent input transportation segments 140A-N of input transportation system 110. Output transportation segment 141A-N may be disposed to receive articles 114 from adjacent output transportation segments 141A-N of output transportation system 112. Tower controller 122A-N may be configured to control vertical storage tower 102A-N, input transportation segment 140A-N of input transportation system 110, output transportation segment 141A-N of output transportation system 112, article placement system 130A-N, and article output apparatus l31A-N, which form module 170A-N of which such tower controller 122A-N a part. Tower controller 122A-N may be configured to communicate with at least one other tower controller 122A-N and a host controller 120.

A vertical storage tower system 100 may be extended or expanded in one or more modular increments. Consider the case where vertical storage tower system 100 may be configured as a set of two modules 170A-N, where N is the second module 170N. In such a case the number of modules 170A-N is two. In such case, vertical storage tower system 100 may be configured to include module 170A and module 170B. Module 170A may be configured to include a vertical storage tower 102A, an input transportation segment 140A, an output transportation segment 141A, a tower controller 122A, an article placement system 130A, and an article output apparatus 131A. Module 170B may be configured to include a vertical storage tower 102B, an input transportation segment 140B, an output transportation segment 141B, a tower controller 122B, an article placement system 130B, and an article output apparatus 131B. Vertical storage tower system 100 may be expanded and reconfigured as a set of three modules 170A-N where module 170N is the third module 170A-N, for example. Module 170N may be configured to include a vertical storage tower 102N, an input transportation segment 140N, an output transportation segment 141N, a tower controller 122N, an article placement system 130N, and an article output apparatus 131N, where module 170N is the third module 170A-N. Such module 170N may for example be disposed adjacent module 170B, to extend vertical tower storage system 100 to include modules 170A-N, where the number of modules 170A-N is three. Consider a similar case where such vertical storage tower system 100 may be expanded from a configuration including modules 170A-N where the number of modules 170A-N is two, to a configuration including modules 170A-N where, for example, module 170N is the tenth module 170A-N, by adding eight modules 170A-N. In such case, the number of modules 170A-N has become ten. Vertical storage tower system 100 may be expanded by virtually any number of modules 170A-N that may be used to advantage.

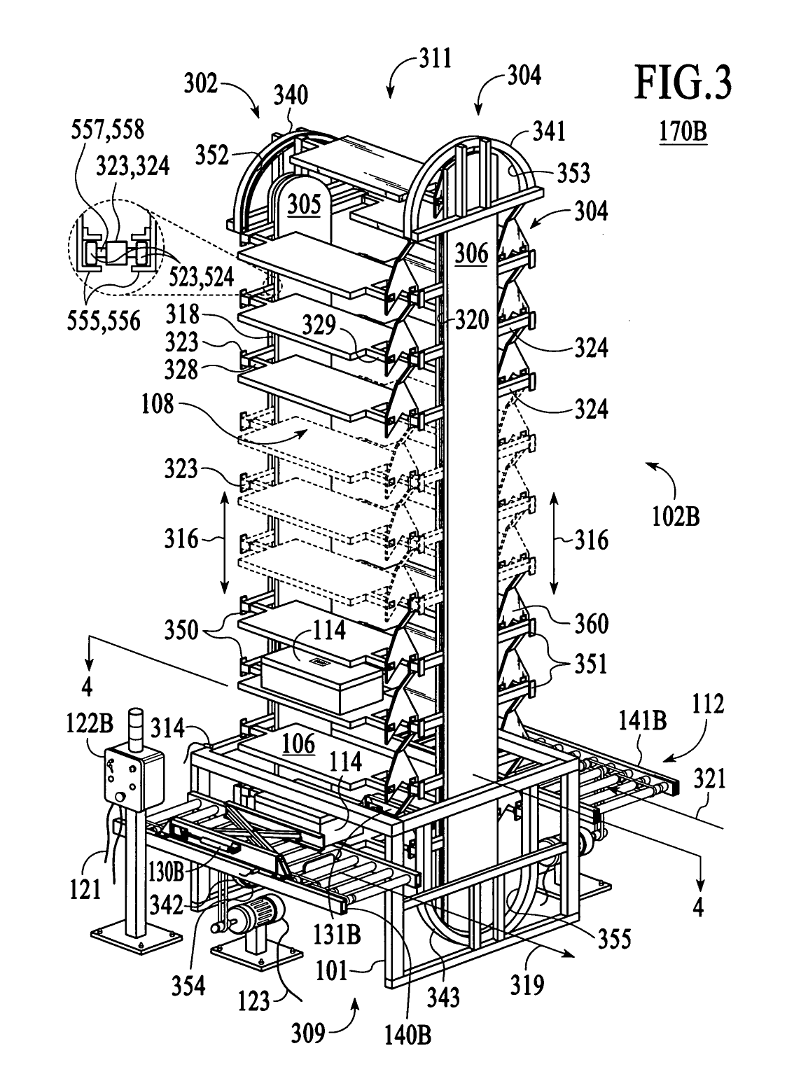

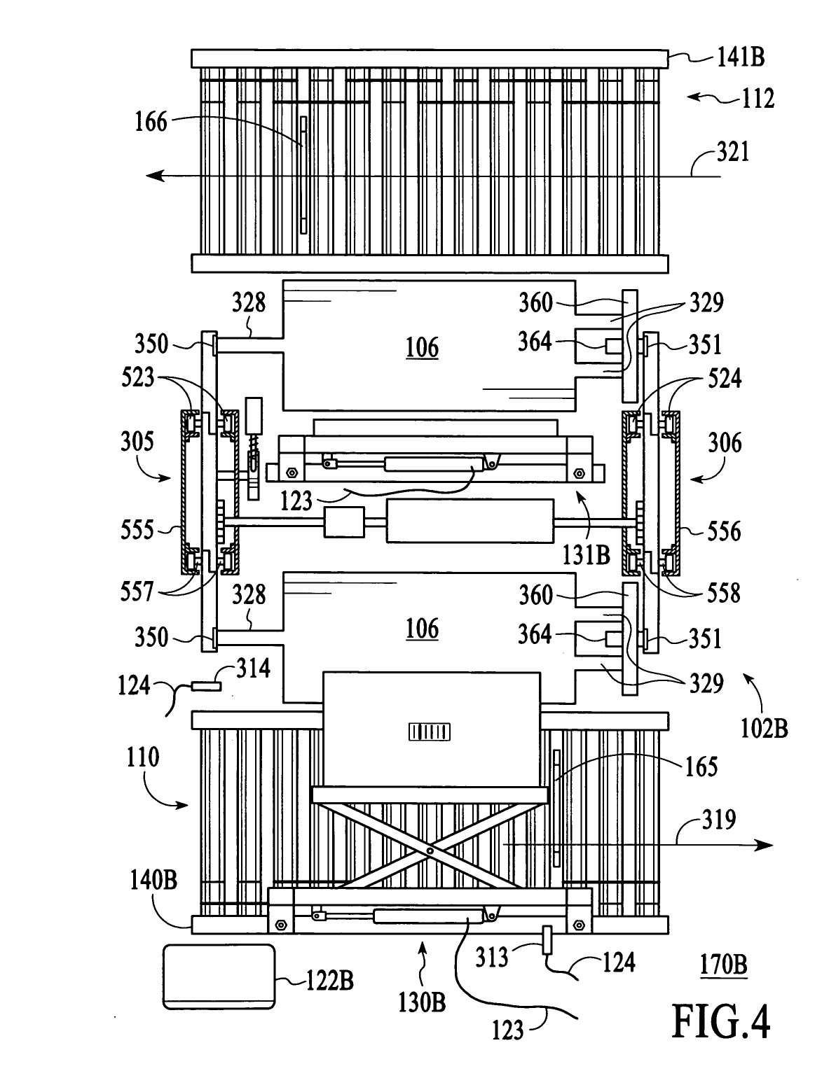

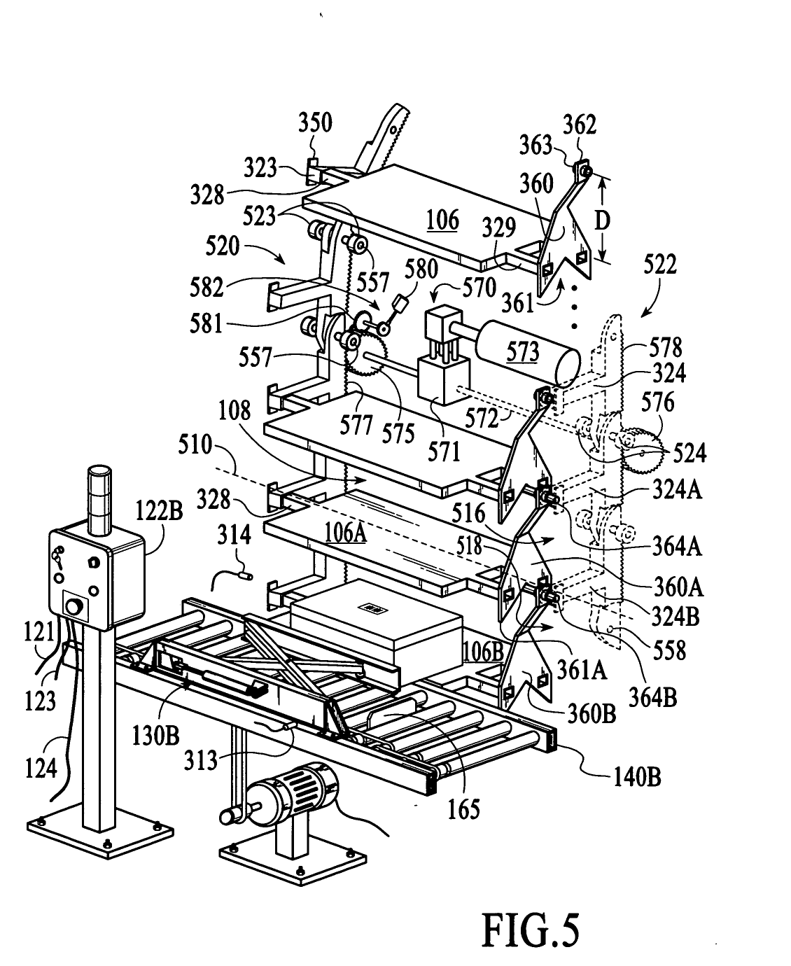

FIG. 3 is a perspective view of one embodiment of a vertical storage tower 102B and FIG. 4 is a plan sectional view along 4-4 of vertical storage tower 102B of FIG. 3 in accordance with aspects of the invention. FIG. 5 is a fragmented perspective view of one embodiment of a vertical storage tower 102B of FIGS. 1 and 3 in accordance with aspects of the invention. Vertical storage towers 102A-N include a tower frame 101. Tower frame 101 is configured to support two shelf guide assemblies 302 and 304. Shelf guide assemblies 302 and 304 are spaced apart to accommodate shelves 106 therebetween. Shelf guide assemblies 302 and 304 are configured to rotatably support and guide shelves 106 along a vertical storage path 316. Guide path assemblies 302 and 304 and shelves 106 define storage locations 108. Storage locations 108 are movable in either direction along vertical storage path 316, which defines an endless loop about a respective vertical storage tower 102A-N. Storage locations 108 may be positioned virtually anywhere along vertical storage path 316. For example, storage locations 108 may be positioned along vertical storage path 316 proximate input transportation segment 140B of input transportation system 110 and output transportation segment 141B of output transportation segment system 112. Tower controllers 122A-N, such as tower controller 122B, may be configured to provide control signals 123 for the processing, i.e., disposition, of articles 114 on a respective vertical storage tower 102A-N disposed adjacent thereto. For example, tower controller 122B may provide control signals 123 to vertical storage tower 102B to control vertical positioning of shelves 106 and therefore storage locations 108 with respect to input transport segment 140B of input transportation system 110 and output transportation segment 141B of output transportation system 112. Shelves 106 in, for example vertical storage tower 102B, move simultaneously along vertical storage path 316 when being positioned under control of control signals 123 from tower controller 122B. However, movement and positioning of shelves 106 in vertical storage tower 102B is independent of all other shelves 106 associated with vertical storage towers 102A and 102N, in both direction and time.

Referring to FIGS. 1 through 4, in one configuration vertical storage towers 102A-N include a plurality of article placement apparatuses 130A-N configured to move articles 114 from input transportation system 110 to shelves 106 of vertical storage towers 102A-N, and a plurality of article output apparatuses 131A-N configured to move articles 114 from shelves 106 to output transportation system 112. Article placement apparatuses 130A-N may be disposed on frame 101 adjacent input transportation system 110. Article output apparatuses 131A-N may be disposed on frame 101 adjacent output transportation system 112. In one configuration, input transportation system 110 is positioned proximate vertical storage towers 102A-N and defines an article input path 319. Article placement apparatuses 130A-N may be disposed proximate respective input transportation segment 140A-N of input transportation system 110 and in relative alignment with input path 319 to move articles 114 therefrom. Article placement apparatuses 130A-N may be configured to move articles 114 from input transportation system 110 to an available storage location 108 disposed proximate input path 319 as described below. As generally illustrated in FIG. 1, FIG. 3, FIG. 4, and FIG. 5, one of article placement apparatuses 130A-N, article placement apparatus 130B is positioning an article 114 from input transportation segment 140B of input transportation system 110 to an available storage location 108 on for example vertical storage tower 102B. Once moved by placement apparatus 130B to available storage location 108 from input transportation system 110, article 114 may be moved about vertical storage path 316 on vertical storage tower 102B. In one configuration, output transportation system 112 is positioned along one or more vertical storage tower 102A-N and defines an output path 321. Article output apparatuses 131A-N may be configured to move articles 114 from shelves 106 to output transportation system 112 as described below. For example, as illustrated in FIG. 2, and FIG. 4, output transportation segment 141B of output transportation system 112 is positioned alongside vertical storage tower 102B and is configured to receive articles 114 (not visible in FIG. 4) from for example a vertical storage tower 102N along output path 321 using article output apparatus 131N. Output transportation system 112 is used to deliver articles from vertical storage towers 102A-N along output path 321 using article output apparatus 131A-N as described further herein.

Referring to FIGS. 3 though 5, in one embodiment, each vertical storage tower 102A-N includes an article detector 313 and a shelf detector 314 coupled to tower controller 122A-N. Article detector 313 may be virtually any type of detector configured to detect a presence of an article 114 disposed proximate thereto. Article detector 313 may virtually any type of detector used to advantage such as an optical detector, infrared detector, light beam system, RFI, magnetic scanner, and the like. Article detector 313 may be used to detect the presence or identity of article 114. For example, as illustrated in FIGS. 3 through FIG. 5, article detector 313 may be an optical detector mounted to frame 101 and positioned to detect articles 114 passing in front of article placement apparatus 130A-N. Thus, when an article 114 is in front of article placement apparatus 130A-N, such article detector 313 may be configured to detect a change in reflected light due to such article 114 positioned proximate thereto. For example, as illustrated in FIGS. 3 through FIG. 5, article detector 313 may be positioned to detect when such articles 114 are in a position proximate vertical storage tower 102A-N and capable of being transferred from input transportation segment 140A-N of transportation system 110 by article placement apparatus 130A-N; such position is a conveyor transfer position. Shelf detector 314 may virtually any type of detector used to advantage such as an optical detector, infrared detector, light beam system, RFI, magnetic scanner, and the like. Shelf detector 314 may be used to detect the presence or identity of shelf 106. For example, as illustrated in FIGS. 3 through FIG. 5, shelf detector 314 may be an optical detector mounted to frame 101 and positioned to detect shelves 106 on a respective vertical storage tower 102A-N adjacent thereto. Thus, when a shelf 106 is in front such shelf detector 314, such shelf detector 314 may be configured to sense a change in reflected light due to such shelf 106 positioned proximate thereto. In one operational embodiment, shelf detector 314 is configured to detect only a first shelf 106 to provide a “zero” shelf location for a respective tower controller 122A-N.

Referring to FIG. 3 and FIG. 5, in one embodiment, shelves 106 are rotatably supported between guide path assemblies 302 and 304. One side of an individual shelf 106 is supported by a member 323 disposed in rotating engagement with guide path assembly 302. Member 323 may be rotatably coupled to shelf 106 using pins, bearings, and fasteners configured to support a rotatable connection therebetween as described below. Another side of such an individual shelf 106 is rotatably supported by a member 324 disposed in rotating engagement with guide path assembly 304. Member 324 may be rotatably coupled to shelf 106, using pins, bearings, flanges, and fasteners configured to support a rotatable connection therebetween as described below. Shelf guide assembly 302 includes a slot 318 defined by a guide assembly cover 305. Slot 318 is configured to support and guide member 323 along vertical storage path 316. Shelf guide assembly 304 includes a slot 320 defined by a guide assembly cover 306. Slot 320 is configured to support and guide member 324 along vertical storage path 316.

Referring to FIG. 3, FIG. 4, and FIG. 5, in one configuration, member 323 rotatably supports a member 328 extending from one side of a shelf 106. Member 324 rotatably supports a shelf flange 360 disposed one side of a shelf 106 distal member 328. In one configuration, member 360 supports a member 329 extending from one side of a shelf 106, distal member 329. Shelf flange 360 extends upwardly from shelf 106 toward a top transition region 311 of vertical storage towers 102A-N. Generally, when shelves 106 are positioned immediately proximate one another and in contact therewith, shelf flange 360 is configured to mechanically engage at an inverted V shaped slot 361 with a pin 364 of a shelf support member 324 that is supporting a lower adjacent shelf flange 360 and shelf 106. Shelf flanges 360 may be configured with such mechanical engagement to maintain a respective shelf 106 attached thereto in about a horizontal position. Shelf flange 360 includes an upper connection end 362 disposed on an end distal shelf 106. Connection end 362 is configured to rotatably engage with a pin 364 with bearing a 363, for example.

In one embodiment, a distance D is a predetermined distance between two or more shelves 106 that defines storage locations 108. To maintain shelf 106 associated therewith in a horizontal position, upper connection end 362 is vertically offset from member 328 by a distance D relative an axis 510. When shelves 106 are in physical contact with one another, a moment arm of shelf flange 360 and a physical contact of pin 364 with an adjacent shelf flange 360 prevents such shelves 106 from rotating. For example, as illustrated in FIG. 5, consider a case of two adjacent shelf configurations 516 and 518. Shelf configuration 516 includes a shelf 106A coupled to a shelf flange 360A supported by a pin 364A on a member 324A. Shelf configuration 518 includes a shelf 106B coupled to a shelf flange 360B supported by a pin 364B on a member 324B. In one configuration, a V slot 361A of shelf flange 360A is in contact with pin 364B. To maintain a horizontal position, without rotating about axis 510, shelf 106A is constrained by a moment arm of shelf flange 360A with respect to the distance between shelf 106A and pin 364A, and a physical connection of pin 364B.

Referring to FIG. 3 and FIG. 5, in one configuration shelves 106 are separated, i.e., not in direct contact with one another when such shelves 106 are moved over top transition region 311 or under a bottom transition region 309 of vertical storage towers 102A-N. Shelf guide assemblies 302 and 304 include an upper guide 340 and 341 and a lower guide 342 and 343, respectively, to guide and support shelves 106 over top transition region 311 and under bottom transition region 309 of shelf guide assemblies 302 and 304. Upper guides 340 and 341 are shaped generally in a semi-circle having a radius of about distance D. Upper guides 340 and 341 are offset vertically by about distance D. Upper guides 340 and 341 include a slotted flange guide 352 and 353 respectively. Lower guides 342 and 343 are shaped generally in a semi-circle having a radius of about distance D. Lower guides 342 and 343 are offset vertically by about distance D. Lower guides 342 and 343 include a slotted flange guide 354 and 355 respectively. Upper guides 340 and 341 and lower guides 342 and 343 are configured to cooperate with members 323 and 324 to maintain shelves 106 in about a horizontal position as they are moved over or under vertical storage tower 102A-N in travel about vertical storage path 316. For clarity, shelves 106 are described as being maintained in about a horizontal attitude throughout travel about vertical storage path 316. However, shelves may be configured in any attitude relative vertical by selecting an angle between shelf flange 360 and shelf 106 for advantage, and maintained in such attitude throughout travel about vertical storage path 316.

In one embodiment, member 323 includes a flange 350 that is configured to slidably engage with slotted flange guide 352 of upper guide 340 and slotted flange guide 354 of lower guide 342. Member 324 includes a flange 351 that is configured to engage with slotted flange guide 353 of upper guide 341 and slotted flange guide 355 of lower guide 343. For example, flange 350 may be rigidly mounted to an end of member 323. Such flange 350 may be shaped to slidably engage with slotted flange guide 352 when moving over the top transition region 311 and slidably engage with slotted flange guide 354 when moving under bottom transition region 309 of vertical storage tower 102A-N. Similarly, flange 351 may be shaped to slidably engage with slotted flange guide 353 when moving over a top transition region 311 of vertical storage tower 102A-N, and slidably engage with slotted flange guide 355 when moving under bottom transition region 309 of vertical storage tower 102A-N.

Referring to FIG. 3, FIG. 4, and FIG. 5, in one embodiment, members 323 are flexibly connected together to form a chain 520 that rotates about a rail member 555. Members 324 are flexibly connected together to form a chain 522 that rotates about a rail member 556. For example, a plurality of members 323 may be connected on adjacent ends disposed proximate rail 555 by a plurality of pins 557 to form chain 520. A plurality of members 324 may be connected on adjacent ends disposed proximate rail 556 by a plurality of pins 558 to form chain 522. In one configuration, members 323 include a plurality of respective rollers 523 extending therefrom which are in slidable contact with rail member 555 and at least a portion of guide assembly cover 305. Members 324 include a plurality of respective rollers 524 extending therefrom, which are in slidable contact with rail member 556 and at least a portion of guide assembly cover 306. Rollers 523 are configured to rotatably support chain 520 on rail member 555 within slot 318. Rollers 524 are configured to rotatably support chain 522 on rail member 556 within slot 320. Chain 520 and chain 522, members 323 and 324 and respective slots 318 and 320 define an endless loop. While for clarity, pins 557 are illustrated linking members 323 together to form chain 520, and pins 558 are illustrated linking members 324 together to form chain 522, other forms of linkage are contemplated such as a rubber linkage, chain link, and the like.

In one configuration, each vertical storage tower 102A-N includes a tower drive system 570. Tower drive system 570 includes a transmission 571, a shaft 572, a motor 573, and a position control system 580. Transmission 571 may be configured from virtually any type of transmission that may be used to advantage such as differential transmissions, fixed gear, variable gear, automatic, and the like, configured to translate power from motor 573 to shaft 572. Motor 573 may be configured from a plurality of motor types including electric motors, pneumatic motors, gas powered motors, and the like. Shaft 572 includes a gear 575 and a gear 576 axially positioned on distal ends of shaft 572. Members 323 include a plurality of gear teeth 577 and members 324 include a plurality of gear teeth 578. Gear teeth 577 and 578 are configured to mesh with respective gears 575 and 576. During operation, motor 573 and transmission 571 axially rotate shaft 572 and gear 575 and gear 576. Such rotation of gears 575 and 576 is imparted to respective gear teeth 577 and 578 to rotate respective chains 520 and 522 along vertical storage path 316.

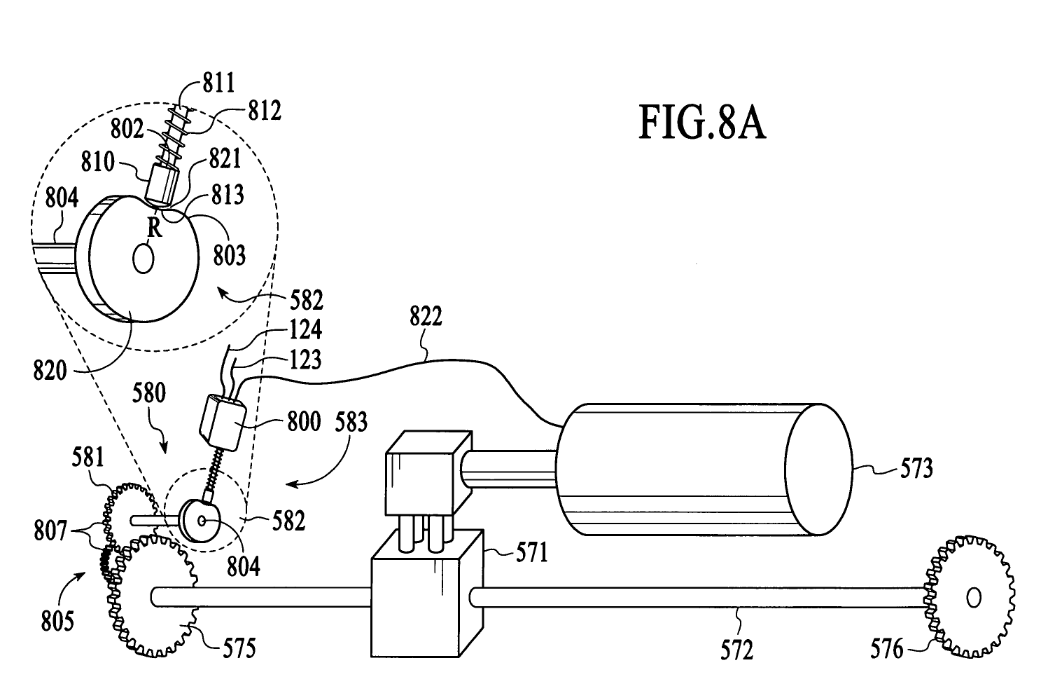

Referring to FIG. 5 and FIG. 8A, in one embodiment, position control system 580 includes a position gear 581 coupled with gear 575, a position detection member 582, and a shelf position detector 583, embodiments which are described further below. For clarity, position gear 581 is coupled with a cluster of gears, including gear 575, however, it is contemplated that position gear 581 may be configured to mesh with gear 576 or gear 575. Position control system 580 is configured to detect a position of at least some of shelves 106 relative a predetermined position along vertical storage path 316. For example, position control system 580 may be configured to determine a relative position of one or more shelves 106 relative positions along vertical storage path 316 associated with input transportation system 110 and output transportation system 112. In one configuration, position control system 580 may be configured such that a position of one or more shelves 106 may be established such that an article 114 may be placed on a shelf 106 from input transportation system 110; such position is defined as an article input position. Further, position control system 580 may be configured to position a shelf 106 such that an article 114 may be positioned for outputting from such a shelf 106 to output transportation system 112; such position is defined as an article extraction position.

Referring to FIG. 1-5, in one embodiment, input transportation system 110 may include two or more input transportation segments 140A-N. Input transportation segments 140A-N may be disposed proximate respective vertical storage tower 102A-N. Input transportation segments 140A-N may be configured to accept articles 114 from adjacent input transportation segments 140A-N. In such configuration, for example input segments 140A-N may be aligned end to end, operationally functioning as a single input transportation system 110. Input transportation segment 140A-N may further include may include one or more stop plates 165. Stop plates 165 may be activated by solenoids, motors, pneumatics, (not shown) and the like to extend above and retract below input transportation system 110 to stop articles 114 in motion along input transportation system 110 adjacent storage locations 108. In one embodiment, output transportation system 112 may include two or more output transportation segments 141A-N. Output transportation segments 141A-N may be disposed proximate vertical respective storage tower 102A-N. Output transportation segments 141A-N may be configured to accept articles 114 from adjacent output transportation segments 141A-N. In such configuration, for example input segments 141A-N may be aligned end to end, operationally functioning as a single output transportation system 112. Output transportation segment 141A-N may further include may include one or more stop plates 166. Stop plates 166 may be activated by solenoids, motors, pneumatics, (not shown) and the like to extend above and retract below output transportation system 112 to stop articles 114 in motion along output transportation system 112. In one operational configuration, when several vertical storage towers 102A-N are positioned inline as illustrated in FIG. 1 and FIG. 2, input transportation segments 140A-N and output transportation segments 141A-N and stop plates 165 and 166 may be controlled by respective tower controllers 122A-N and host controller 120 to prevent an article 114 from continuing beyond a designated vertical storage tower 102A-N, on input and output transportation system 110 and 112 respectively.

In summary, vertical storage towers 102A-N include shelves 106 that are rotated in either a forward vertical direction or a retrograde vertical direction, along a vertical storage path 316 and maintain a relatively flat horizontal position relative ground to help maintain one or more articles 114 that may be disposed thereon. A position along vertical storage path 316 may be controlled at least in part by tower controller 122A-N. Shelves 106 are rotatably hung in between two shelf guide assemblies 302 and 304. Shelf guide assemblies 302 and 304 are vertically offset and include a plurality of members 323 forming a chain 520 and a plurality of members 324 forming another chain 522. Members 323 may be configured to rotatably support one side of a shelf 106 via member 328. Member 328 may be positioned about in parallel with a top surface of such shelf 106. Members 324 may be configured to rotatably support another side of shelf 106 via member 329. Member 329 may be positioned about parallel with such top surface of shelf 106 and positioned distal member 328. Member 328 is supported by a shelf flange 360 extending vertically from such top surface of shelf 106. An offset distance D between member 323 and a connection point 362 of shelf flange 360, and mechanical contact between a pin 361 and an inverted V slot of shelf flange 360, constrains shelf 106 in about a horizontal position as shelves 106 are positioned along vertical storage path 316. Upper guides 340 and 341 are associated with lower guides 342 and 343 of respective shelf guide assemblies 302 and 304. Upper guides 340 and 341 and lower guides 342 and 343 cooperatively guide shelves 106 over and under vertical storage tower 102A-N. In one configuration, a position control system 580 is used to position shelf 106 along vertical storage path 316 relative input transportation system 110 and output transportation system 112. In one embodiment, stop plates 165 may be used to control a flow of articles 114 along input transportation system 110. Stop plates 166 may be used to control a flow of articles 114 along output transportation system 112.

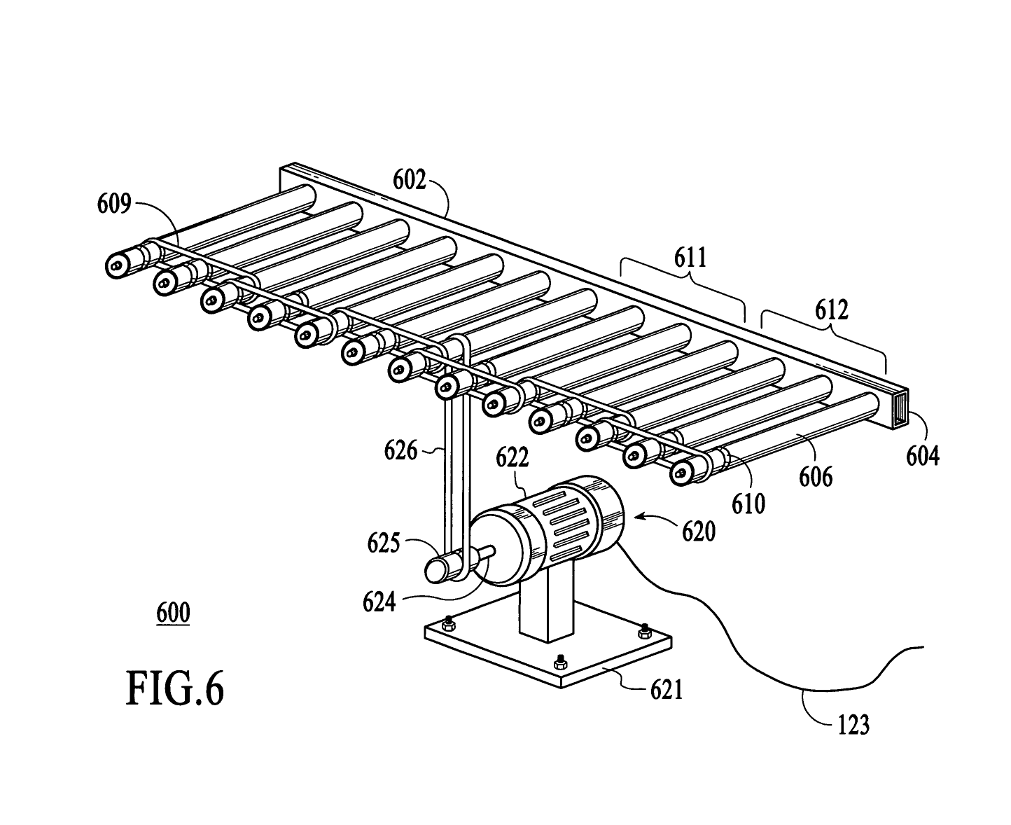

FIG. 6 is a fragmented perspective view of one embodiment of a conveyor segment 600 that may be used with input transportation system 110 and output transportation system 112 in accordance with aspects of the invention. In one embodiment, input transportation segment 140A-N may include conveyor segment 600. In one embodiment, output transportation segment 141A-N may include conveyor segment 600. Conveyor segment 600 includes a frame support 602 and a rail 604 configured to rotatably support a plurality of rollers 606. Frame support 602 may be formed of ridged materials such as steel, plastic, wood, and the like, capable of supporting operation of input and output transportation system 110 and 112. Rail 604 is rotatably coupled to rollers 606. Rollers 606 are configured to rotatably support articles 114 thereon. In one embodiment, rollers 606 include one or more grooves 610 configured to support one or more drive bands 609 coupled thereto. Drive bands 609 may be formed of polymer materials such as plastics, rubbers, nylon, and the like configured to fit about within grooves 610 of one or more adjacent rollers 606. For example, as illustrated in FIG. 6, a roller set 611 of three adjacent rollers 606 are connected together via one or more drive bands 609. To couple several sets of adjacent roller sets 611 together, one or more bands 609 may be connected to one roller 609 of a roller set 611 to another roller 609 of another adjacent roller set 612.

Conveyor segment 600 includes a motor drive system 620. Motor drive system 620 may include a base 621 configured to support a motor 622 thereon. Motor 622 may be configured from a plurality of motor types including electric motors, pneumatic motors, gas powered motors, and the like. For example, motor 622 may be an electric motor coupled to an electrical power control such as tower controller 122A-N via input signal 123. In one configuration, motor 622 includes a shaft 624 extending therefrom. Shaft 624 includes a bushing 625 configured to accept a drive band 626 thereon. Drive band 626 may be configured to couple power from motor 622 to one roller 606 of roller set 611 to impart rotation thereto. For example, drive band 626 may be slidably coupled to bushing 625 and to a groove 610 of one roller 606. Such a roller 606 may then be coupled to sets of other rollers 606 such as adjacent roller set 611 and another adjacent roller set 612. In another configuration, motor drive system 620 may be combined with and internal to a roller 606 to form a powered roller. In one operational configuration, conveyor segment 600 may be controlled via signal connection 123 such that as articles 114 are moved along conveyor segment 600, a speed of motor 622 and rollers 606 may be controlled to position such articles 114 along article input path 319 and article output path 321.

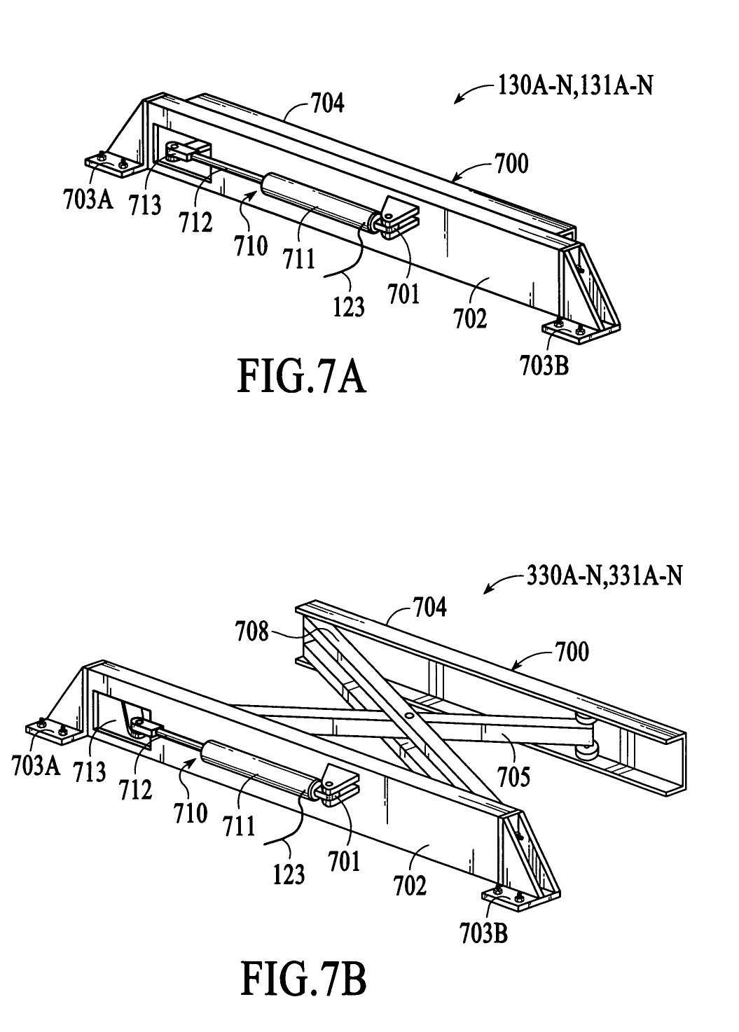

FIG. 7A and FIG. 7B are perspective views of one embodiment of an article positioning apparatus 130A-N,131A-N in accordance with aspects of the invention. Article positioning apparatus 130A-N is configured to expand and contract to move articles 114 from input transportation system 110 to one or more vertical storage towers 102A-N. Article positioning apparatus 131A-N is configured to expand and contract to move articles 114 from one or more vertical storage towers 102A-N to output transportation system 112. Article positioning apparatus 130A-N and 131A-N include an extension apparatus 700. Extension apparatus 700 includes a base 702 coupled to a push member 704 via a scissor assembly 708. Base 702 includes mounting flange 703A on one end and another mounting flange 703B on another end. Mounting flanges 703A and 703B may be configured to mount base 702 to frame 101, for example, as illustrated in FIG. 1 and FIG. 3. Article positioning apparatus 130A-N and 131A-N include a scissor activator system 710. In one embodiment, scissor activator system 710 includes a scissor drive 711 having a shaft member 712 extending therefrom, connected to a pivot arm 713. Scissor drive 711 is secured to base 702 at a bracket 701 distal pivot arm 713. Pivot arm 713 is pivotally connected to an extension arm 705. Scissor drive 711 may be activated using any number of control signals 123 such as pneumatic signals, electrical signals, and the like. For example, scissor drive 711 may be a pneumatic solenoid configured to operate with one or more pneumatic types of control signals 123 wherein such control signals 123 are air signals. In one configuration, control signal 123 may include pressurized air that retracts shaft member 712 into scissor drive 711, urging pivot arm 713 in the direction of bracket 701. Pivot arm 713 urges rotating extension arm 705 counterclockwise to an open position forcing push member 704 outward as illustrated in FIG. 7B. Input air control signal 123 may include pressurized air that extends shaft member 712 from scissor drive 711, urging pivot arm 713 away from bracket 701. Pivot arm 713 urges rotating extension arm 705 clockwise to a closed position forcing push member 704 to retract as illustrated in FIG. 7A. Similarly, signals 123 may be air signals wherein a vacuum is applied to contract and extend scissor drive 711, thereby rotating arm 705 to a to an open position and closed position respectively.

FIG. 8A is a perspective view of one embodiment of a shelf position detector 583 in accordance with aspects of the invention. Shelf position detector 583 includes a position feedback circuit 800 mechanically coupled to position a detection member 582. Shelf position detector 583 associates a change in distance between a plunger 802 and a surface 803 of detection member 582. A shaft 804 is axially coupled to position gear 581. In one configuration, position gear 581 is coupled to a shaft 572 via a gear system 805. Gear system 805 may include one or more gears 807 configured to step up or down and set the rotational direction of shaft 804. Plunger 802 includes a head 810 on one end of a plunger shaft 811. Head 810 may be held against surface 803 via a spring 812. In one embodiment, position feedback circuit 800 controls a speed and position of shelves 106 though changes in a distance of travel of plunger head 810 relative shaft 805.

For example, in one embodiment, surface of detection member 582 includes a cardioid shaped surface 813. Cardioid shaped surface 813 includes a generally round outer portion 820 and a valley portion 821. Valley portion 821 defines a cardiod shaped slope that varies in radius R relative shaft 804. Position feedback circuit 800 controls a speed of motor 573 corresponding to radius R. For example, motor speed increases with increasing radius R and decrease with a diminishing radius R. Cardioid shaped surface 804 provides a predetermined motor speed profile wherein a shelf 106 may approach a loading or unloading position wherein the radius R is greater and therefore the motor speed is greater and diminish as such shelf 106 reaches a predetermined proximity to such loading or unloading position. For example, if valley portion 821 is associated with an input and output shelf position, when a shelf approaches such an unloading or loading position, position feedback circuit 800 will detect a smaller radius R within valley portion 821 and decrease such motor speed accordingly. In one embodiment, position feedback circuit 800 stops motor 573 and therefore a travel of such a shelf 106 in desired alignment with such input and output position.

In one embodiment, shelf position detector 583 may be configured as an open loop shelf counter. For example, a distance traveled by chains 520 and 522 of about one shelf, e.g., distance D, may equal about one rotation of cardioid shaped surface 813, e.g., valley portion 821 may be associated with a shelf 106 passing an input and output position thereof. Therefore, in one operational configuration, shelf position detector 583 may associate a number of rotations of cardioid shaped surface 813 with a number of shelves moving past a “zero” point along vertical storage path 316. For example, consider the case where shelf detector 314 detects one shelf 106 with indicia indicative of a zero shelf 106, until shelf detector 314 detects such zero shelf, subsequent shelves passing proximate thereto may be counted, e.g., one, two, three, four, etc. Such shelf count may be stored as shelf count data in tower controller 120 and tower controller 122A-N for later retrieval therefrom. For example, an article 114 may be stored at shelf count four of vertical storage tower 102B. While for clarity, shelf position detector 583 may associate a number of single rotations of cardioid shaped surface 813 with a shelve 106 moving past such a zero point along vertical storage path 316, other counting sequences are contemplated such as two or three rotations of cardioid shaped surface 813 per shelf 106 crossing an input and output position.

FIG. 8B is a high level schematic of one embodiment of a shelf position feedback circuit 800 in accordance with aspects of the invention. Shelf position feedback circuit 800 is mechanically connected to a plunger 802 where plunger operation changes a voltage output value of a potentiometer 834. Potentiometer 834 is electrically coupled across a power source 835 such that a movement of a wiper 836 provides a voltage output Vout of between zero and Vbb. Vout is coupled to a switch 837. In one configuration, switch 837 may be normally closed (NC) double pole single throw such that Vout is coupled to a motor control circuit 840 via a signal 841. Motor control circuit includes a speed control circuit 842 and a motor direction control circuit 843. When plunger 802 is moved a predetermined distance, a plunger actuator 839 opens both poles of switch 835. One pole of switch opens to disconnect Vout from motor control circuit 840. Another pole of switch 835 opens indicating a position of shelf 106 to, for example, a tower controller 122A-N (not shown), via signal 124. When plunger 802 is in another position, a Vout may be applied to speed control circuit 842 via signal 841 to control a speed of motor 573. A control signal 123 may be applied to motor direction control circuit 843 to control a direction of rotation of motor 573 and therefore a direction of travel of shelves 106 along vertical storage path 316. Control signal 123 may also be used to control a plunger 851 of a solenoid 850 to effect a restart of motor 573 by bypassing switch 837 when open. Motor control circuit 840 applies voltage via a signal 822 to drive a motor 573 in a predetermined direction at a predetermined speed. While for clarity, switch 837 is illustrated as a double pole, single throw switch, (DPST) mechanically coupled to motor control circuit 840, other switch types are contemplated, for example magnetic, reed, optical, SPST, SPDT, DPDT, etc., or any combination thereof. It is further contemplated that switch 837 may couple Vout to motor control circuit 840 via for example, mechanical relays, electromagnetic relays, analog circuitry, digital logic, solid state relays, and the like that may be configured to perform the embodiments of the present invention to advantage.

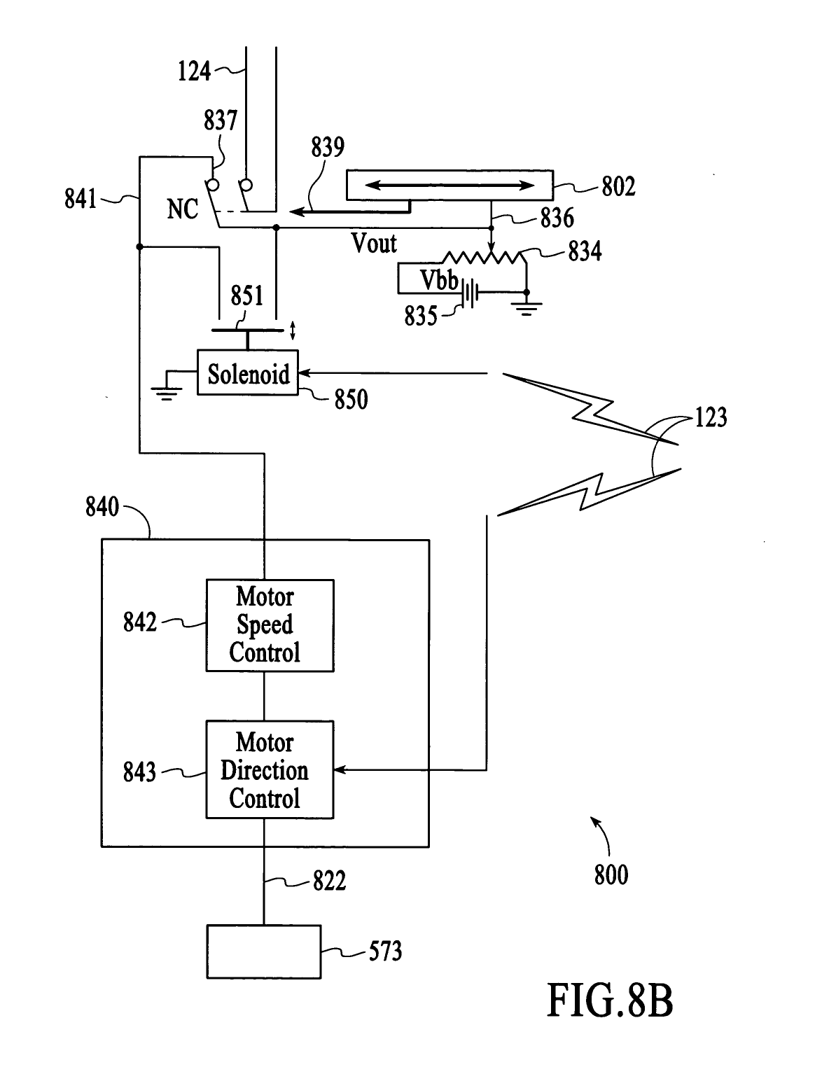

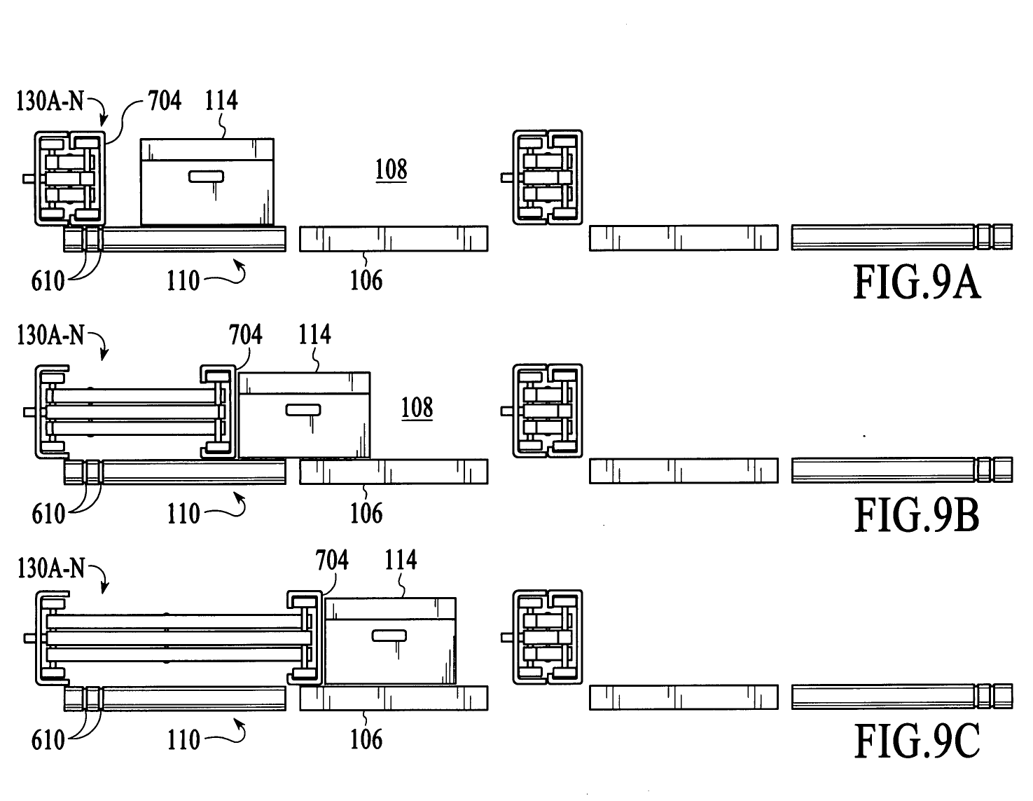

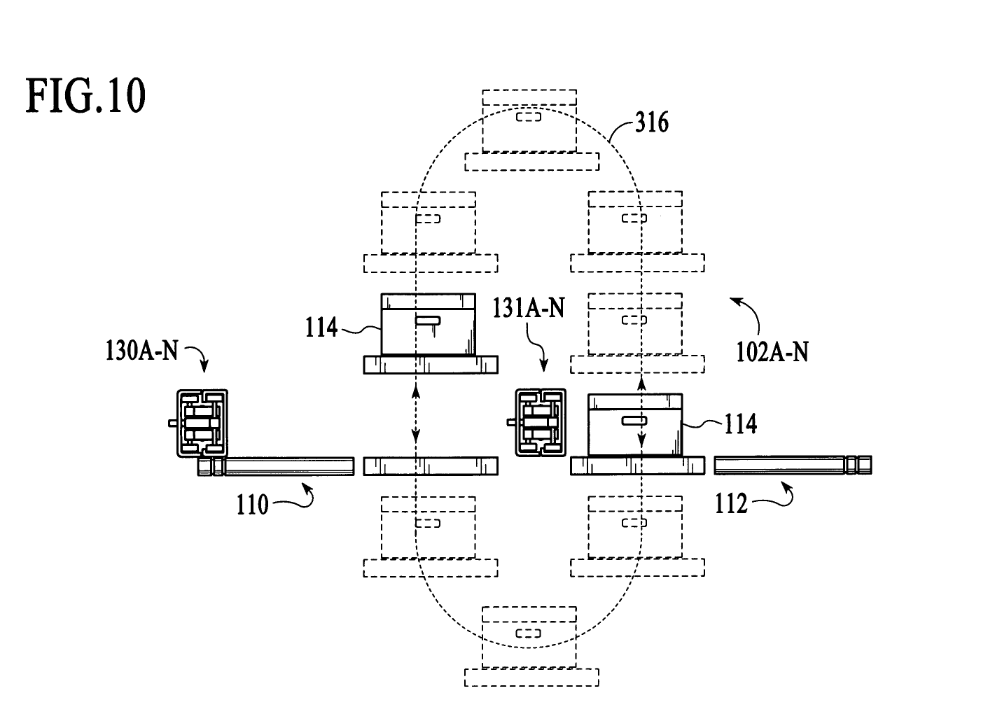

FIGS. 9A through 9C is a high level view of one operational embodiment for transferring articles 114 from an input transportation system 110 to an available storage location 108 within a vertical storage tower 102A-N (not shown). FIG. 10 is a high level view of one operational embodiment for storing articles 114 on a vertical storage tower 102A-N. FIGS. 11A through 11C is a high level view of one operational embodiment for moving articles 114 from a vertical storage tower 102A-N (not shown) to an output transportation system 112 in accordance with aspects of the invention. Loading articles 114 may be accomplished by transferring articles 114 from input transportation system 110 to available storage location 108 within vertical storage tower 102A-N. Unloading articles 114 may be accomplished by transferring articles 114 from vertical storage tower 102A-N to output transportation system 112. Storage of articles 114 may be accomplished by permitting a loaded article 114 to remain within available storage location 108 on vertical storage tower 102A-N, until unloading of such article 114 is desired regardless of a number of intervening operations of loading, and unloading. For clarity, FIGS. 9A-C, FIG. 10, and FIGS. 11A-C illustrate a sequence of loading and unloading articles 114 from one or more vertical storage towers 102A-N. However, loading, unloading, and storage of articles 114 are asynchronous, e.g., independent, functions. Therefore, vertical storage tower system 100 may be configured to provide simultaneous loading, unloading, and storage of articles 114. In one operational illustration, FIG. 9A illustrates an article 114 being transferred on an input transportation system 110. FIG. 9B illustrates an article 114 being partially transferred from input transportation system 110 to a shelf 106. FIG. 9C illustrates an article 114 being fully transferred from input transportation system 110 to a shelf 106 via article placement apparatus 130A-N. FIG. 10 illustrates an article 114 stored on a shelf 106 and transferred about vertical storage path 316. One or more articles 114 may be stored on shelves 106 that are positioned about vertical storage tower 102A-N. FIG. 11A illustrates an article 114 being partially transferred from a shelf 106 via an article output apparatus 131A-N. FIG. 11B illustrates an article 114 being fully transferred from shelf 106 to an output transportation system 112 via an article output apparatus 131A-N. FIG. 11C illustrates an article 114 having been fully transferred from shelf 106 to output transportation system 112.

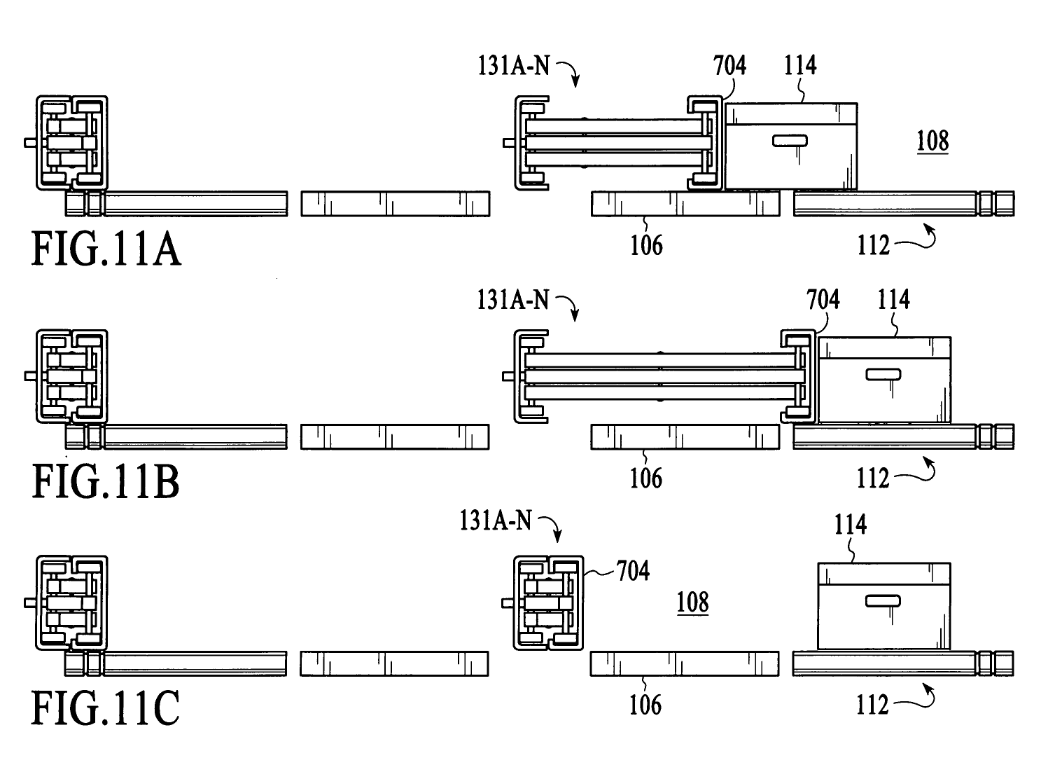

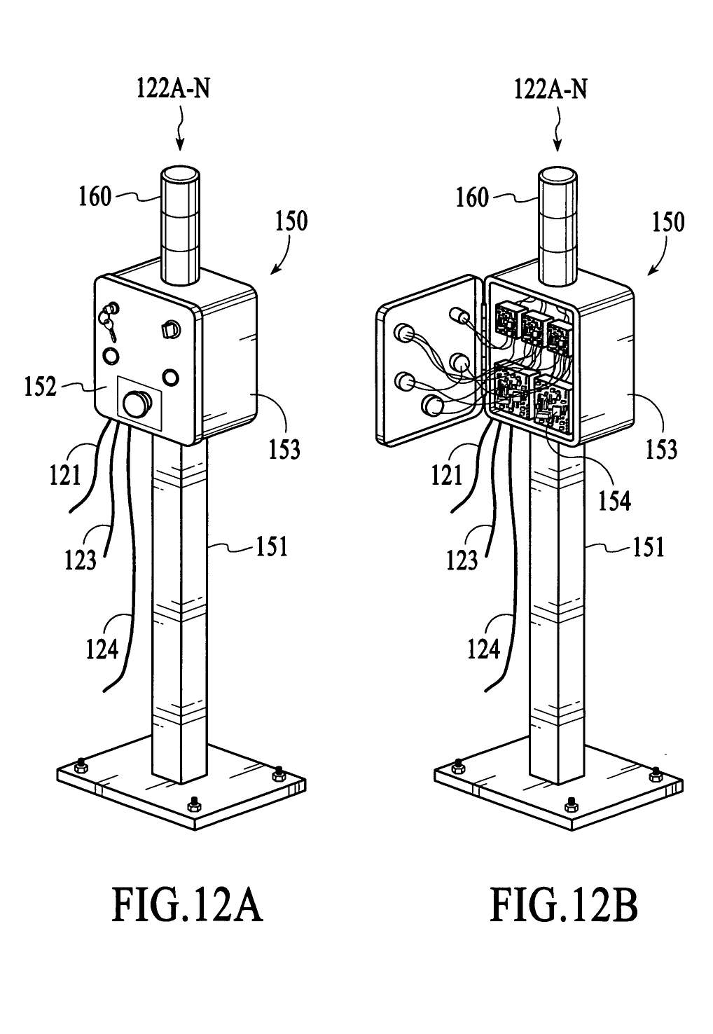

FIG. 12 is a perspective view and FIG. 13 is high level block diagram of a vertical storage tower controller 122A-N in accordance with aspects of the invention. Vertical storage tower controller 122A-N may be virtually any type of data processing system such as a laptop computer, desk top computer, mainframe, personal data assistant (PDA), and the like, that may be configured to perform embodiments of the present invention to advantage. Vertical storage tower controller 122A-N may be configured to operate one or more vertical storage towers 102A-N, independently of a host controller 120. In one configuration, vertical storage tower controller 122A-N includes a frame 150 including a pedestal 151. Frame 150 may be include a variety of materials such as metal, plastics, and the like that support operation of vertical storage tower controller 122A-N. Vertical storage tower controller 122A-N includes a control panel 152. In one embodiment, control panel 152 may be hingedly attached to an electrical control box 153 to permit ease of access an interior of control box 153 for installation, maintenance, upgrading, and the like. Control panel 152 includes a plurality of buttons and switches for manual control of a proximate vertical storage tower 102A-N and associated input transportation system 110 and output transportation system. Electrical control box 153 includes control circuitry 154 some of which is described herein. Vertical storage tower controller 122A-N may include a light 160 disposed thereon to alert a user of a status condition.

FIG. 13 is a high level block diagram of a vertical storage tower controller 122A-N in accordance with aspects of the invention. In one embodiment, vertical storage tower controller 122A-N includes a CPU 1300, memory 1310, and an I/O interface 1320 in communication therewith via a bus 121. Bus 121 may be configured to couple data associated with the transmission of data from input signal 124 from one or more input devices 1324 such as an article detector system 116, an article detector 313, a shelf position state of switch 837, a shelf detector 314, a control panel 152, a host controller 120, and tower controllers 122A-N to CPU 1300, memory 1310 and I/O interface 1320, for example. Buss 121 may be configured to transmit output data and instruction from CPU 1300 and memory 1310 to one or more output devices 1326 such as article placement apparatus 130A-N, article output apparatus 131A-N, a motor direction control 843, a bypass relay 851, a stop plate 165, a stop plate 166, light 160, host controller 120, and tower controllers 122A-N via output control signals 123. I/O interface 1320 may communicate with wireless devices via an antenna 1321.

CPU 1300 may be under the control of an operating system that may be disposed in memory 1310. Virtually any operating system or portion thereof supporting the configuration functions disclosed herein may be used. Memory 1310 is preferably a random access memory sufficiently large to hold the necessary programming and data structures of the invention. While memory 1310 is shown as a single entity, it should be understood that memory 1310 may in fact comprise a plurality of modules, and that memory 1310 may exist at multiple levels, from high speed registers and caches to lower speed but larger direct random access memory (DRAM) chips to virtual memory on data storage devices, for example magnetic disks.

Illustratively, memory 1310 may include a tower control program 1314 that, when executed on CPU 1300, controls at least some data processing operations of a vertical storage tower system 100. The tower control program 1314 may use any one of a number of different programming languages. For example, the program code can be written in PLC code (e.g., ladder logic), a higher-level language such as C, C++, Java, or a number of other languages. While tower control program 1314 may be a standalone program, it is contemplated that tower control program 1314 may be combined with other programs.

In one embodiment, memory 1310 may include a storage locations data 1316 indicative of a status of storage locations 108 (see FIG. 1). Storage locations data 1316 may utilize and be part of a database program such as Microsoft Access™, Oracle® database, and other data base programs configured to store data for processing thereof. Storage locations data 1316 may be processed by CPU 1300 to process information associated with storage and disposition of articles 114.

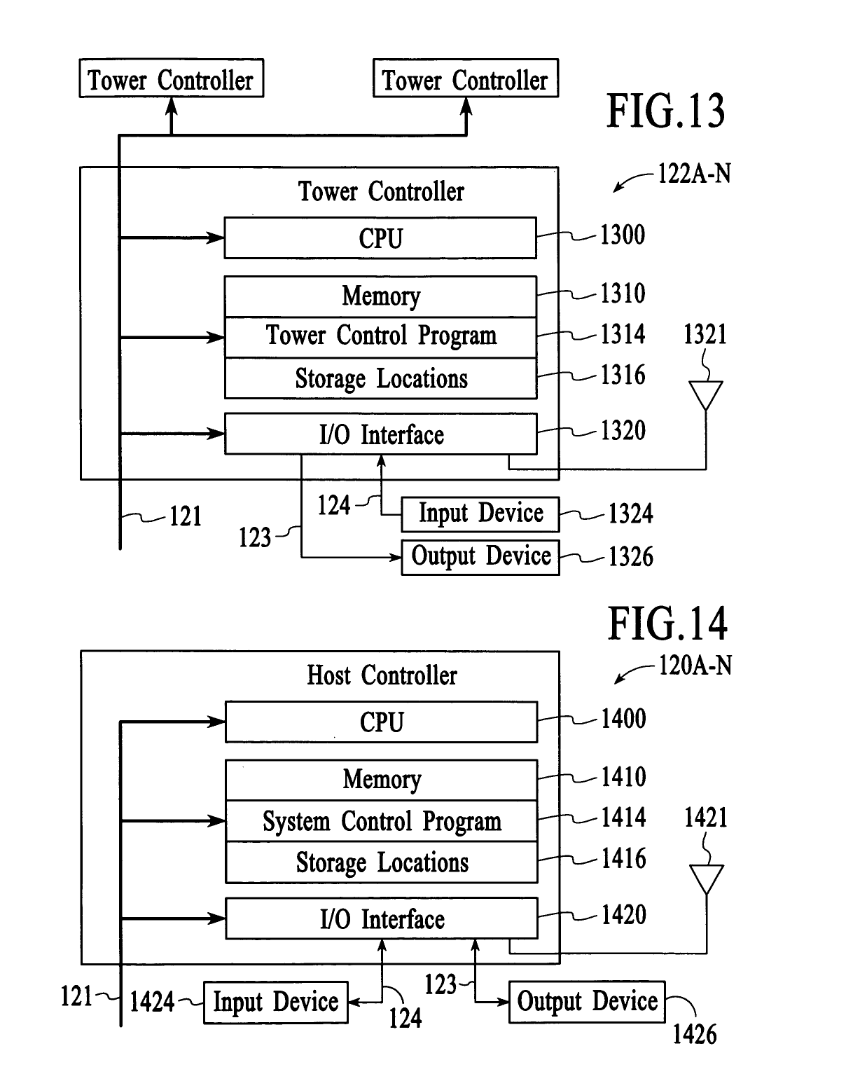

FIG. 14 is high level block diagram of a host controller 120 in accordance with aspects of the invention. Host controller 120 may be virtually any type of data processing system such as a laptop computer, desk top computer, mainframe, personal data assistant (PDA), and the like, that may be configured to perform embodiments of the present invention to advantage.

In one embodiment, host controller 120 includes a CPU 1400, a memory 1410, and an I/O interface 1420 in communication therewith via bus 121. Bus 121 may be configured to couple data associated with the transmission of data from an input signal 124 via from one or more input devices 1424 such as an article detector system 116, an article detector 313, a shelf position state of switch 837, a shelf detector 314, control panel 152, and tower controllers 122A-N to CPU 1400, memory 1410 and I/O interface 1420, for example. Buss 121 may be configured to transmit output data and instruction from CPU 1400 and memory 1410 to one or more output devices 1426, such as article placement apparatus 130A-N, article output apparatus 131A-N, a motor direction control 843, a bypass relay 851, a stop plate 165, a stop plate 166, light 160, and tower controllers 122A-N via output control signals 123. I/O interface 1420 may communicate with wireless devices via an antenna 1421.

CPU 1400 may be under the control of an operating system that may be disposed in memory 1410. Virtually any operating system or portion thereof supporting the configuration functions disclosed herein may be used. Memory 1410, similar to memory 1310, is preferably a random access memory sufficiently large to hold the necessary programming and data structures of the invention. While memory 1410 is shown as a single entity, similar to memory 1310, it should be understood that memory 1410 may in fact comprise a plurality of modules, and that memory 1410 may exist at multiple levels, from high speed registers and caches to lower speed but larger direct random access memory (DRAM) chips to virtual memory on data storage devices, for example magnetic disks.

Illustratively, memory 1410 may include a host control program 1414 that, when executed on CPU 1400, controls at least some data processing operations of vertical storage tower system 100. The host control program 1414, as with tower control program 1314, may use any one of a number of different programming languages. For example, the program code can be written in PLC code (e.g., ladder logic), a higher-level language such as C, C++, Java, or a number of other languages. While host control program 1414 may be a standalone program, it is contemplated that host control program 1414 may be combined with other programs such as tower control program 1314.

In one embodiment, memory 1410 may include a storage locations data 1416 indicative of a status of storage locations 108 (see FIG. 1), status of articles 114, etc. Storage locations data 1416 as with storage locations data 1316 may utilize and be part of a database program such as Microsoft Access™, Oracle® database, and other data base programs configured to store data for processing thereof. Storage locations data 1416 may be processed by CPU 1400 to process information associated with storage and disposition of articles 114 associated with vertical storage tower system 100. In one embodiment, a vertical storage tower 122A-N may also function as host controller 120.

In one article storage operational embodiment, an article 114 may be placed by an operator 103 on an input transportation system 110, for example an input conveyor. A host controller 120 may be provided an identity of article 114 by operator 103, or may determine identity of article 114 from an article detector system 116, such as a barcode reader, as host controller 120 moves input article 114 on transportation system 110, proximate article detector system 116. An available storage location 108 may be identified on for example a vertical storage tower 102B of an array of vertical storage towers 102A-N, by a respective tower controller 122B. Host controller 120 in communication with tower controllers 122A-N may move article 114 on input transportation system 110 to a conveyor transfer position proximate vertical storage tower system 102B. Tower controller 122B may determine from an article detector 313 that article 114 has arrived at such conveyor transfer position. Tower controller 122B may rotate one or more shelves 106 on vertical storage tower 102B until available storage location 108 is proximate input transportation system 110 at a article input position. Tower controller 122B may actuate an article placement system 130B to transfer article 114 from input transportation system 110 to available storage location 108 on respective shelf 106. Identity of article 114 may be associated with available storage location 108 of such article 114 in storage locations data 1316 of memory 1310 in tower controllers 122A-N as well as in storage locations data 1416 of memory 1410 in host controller 120. Article 114 may stored in available storage location 108 indefinitely and independently of storage and retrieval activities for other articles 114.

In one article retrieval operational embodiment, a requested article 114 may be retrieved from an array of vertical storage towers 102A-N virtually at any time, and in virtually any order with respect to other stored articles 114. Upon a request by a host controller 120 to one or more tower controllers 122A-N, an article storage location 108 for requested article 114 may be identified on, for example, a vertical storage tower 102A, by a respective tower controller 122A. For example, an identity of requested article 114 may be associated with such article storage location 108 in storage locations data 1316 of memory 1310 on tower controllers 122A-N as well as in storage locations data 1416 of memory 1410 in host controller 120. Tower controller 122A may rotate one or more shelves 106 on vertical storage tower 102A until such storage location 108 containing requested article 114 is in a article extraction position, proximate an output transportation segment 141A of output transportation system 112. Tower controller 122A may actuate an article removal system 131A to transfer requested article 114 from vertical storage tower 102A to output transportation system 112, for example an output conveyor. Host controller 120 in communication with tower controllers 122A-N may move requested article 114 on output transportation system 112 to a discharge position, for example to be retrieved by operator 103.

Rotation of vertical storage tower 102B is asynchronous. This means for example, tower controller 122B may rotate vertical storage tower 102B independently of all other vertical storage towers 102A-N, in direction and time. Likewise, tower controller 122A may rotate vertical storage tower 102A asynchronously, or independently of vertical storage tower 102B and other vertical storage towers 102A-N, in direction and time, for example. Moreover, any tower controller 122A-N may rotate respective vertical storage tower 102A-N asynchronously, or independently of movement, coordinated by host controller 120 and tower controllers 122A-N, of articles 114 on input transportation system 110 and output transportation 112. For example, tower controller 122B may rotate shelves 106 on vertical storage tower 102B to article input position proximate input transportation system 110, at the same time as host controller 120, in coordination with tower controllers 122A-N, including tower controller 102B, may move one or more articles 114 on input transportation system 110 to conveyor transfer position, proximate vertical storage tower 102B. Also, at the same time tower controller 122A may rotate shelves 106 on vertical storage tower 102A to article extraction position, proximate output transportation system 112. Also, at the same time host controller 120, in coordination with tower controllers 122A-N, may move one or more articles 114 on output transportation system 112 to discharge position.

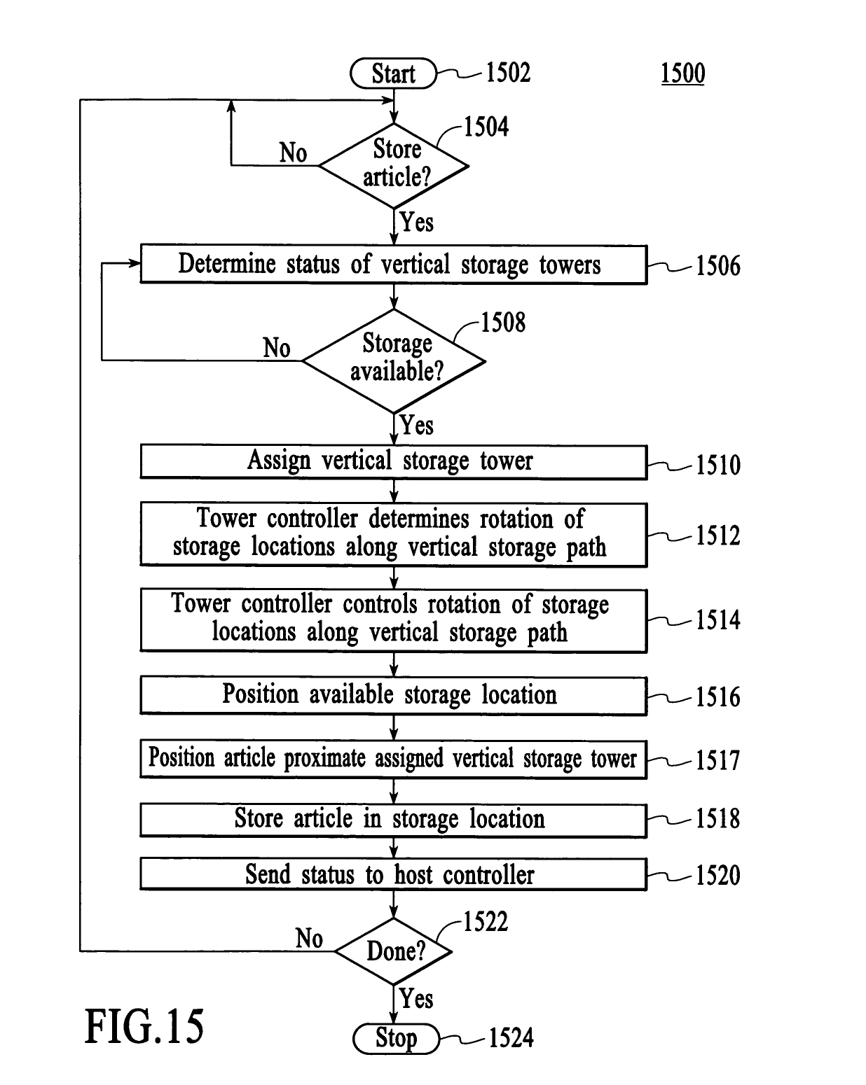

FIG. 15 is a flow diagram of a method 1500 to determine storage disposition of articles processed by a vertical storage tower system 100 in accordance with aspects of the invention. Method 1500 may be entered into at 1502 for example by activating a host control program 1414 or tower control program 1314 associated with vertical storage tower system 100. At 1504, method 1500 determines if an article 114 is to be stored. If an article 114 is not to be stored, then at 1504, method 1500 continues to check for articles 114 to be stored, for example, articles 114 being inputted on input transportation system 110. In one operational configuration, host control program 1414 and detector 116 cooperate to determine whether or not one or more articles are being input to vertical storage system 100 by a user 103 thereof (see FIG. 1). If one or more articles 114 are to be stored, at 1506 method 1500 determines a status of a plurality of vertical storage towers 102A-N, for example. In one operational configuration, host controller 120 and tower controllers 122A-N communicate via a bus 121 to determine one or more status conditions, e.g., status conditions such as availability or non-availability, of movable storage locations 108. For example, detectors 313 and 314, and position control system 580 may provide input data to tower controller 122A-N to determine an availability of movable storage locations 108 associated therewith to store one or more articles 114. In one embodiment, storage locations data 1316 from memory 1310 may be used in cooperation with tower control program 1314 to determine the position of available movable storage locations 108. At 1508, if one or more movable storage locations 108 are available, on one or more vertical storage towers 102A-N, to store articles 114, then at 1510, one of such plurality of vertical storage towers 102A-N are associated with one or more articles 114 to be stored, e.g, such one or more articles 114 are assigned to a particular vertical storage tower 102A-N, such as vertical storage tower 102B. If at 1508 one or more vertical storage towers 102A-N are not available to store articles 114, then method 1500 returns to 1506. At 1512, method 1500 determines an available storage location 108, for example, on assigned vertical storage tower 102B to use for storing such one or more articles 114. In one embodiment, storage locations data 1316 from memory 1310 may be used in cooperation with tower control program 1314 to determine the position of such available movable storage location 108 on tower 102B to use. At 1514, method 1500 rotates movable storage locations 108 along a vertical storage path 316, for example, to position such predetermined movable storage location 108 proximate to such one or more articles 114 positioned proximate thereto. At 1516, such predetermined movable storage location 108 is positioned along vertical storage path 316 proximate input transfer system 110. At 1517, method 1500 positions such one or more articles 114 on input transfer system 110, proximate vertical storage tower 102B. In one operational configuration, host controller 120 and tower controllers 122A-N communicate via a bus 121 to control input transfer system 110. At 1518, such one or more articles 114 are transferred from an input position to one or more movable storage locations 108 associated therewith. At 1520, method 1500 communicates a status of such stored articles to tower controller 120 and host controller 122A-N for example. If at 1522, method 1500 is not finished, method 1500 proceeds to 1504. If however at 1522 method 1500 is finished, method 1500 ends at 1524. Method 1500 is asynchronous and multitasking. For example, method 1500 may execute at 1517 at the same time as, before, or after method 1500 executes at 1514.

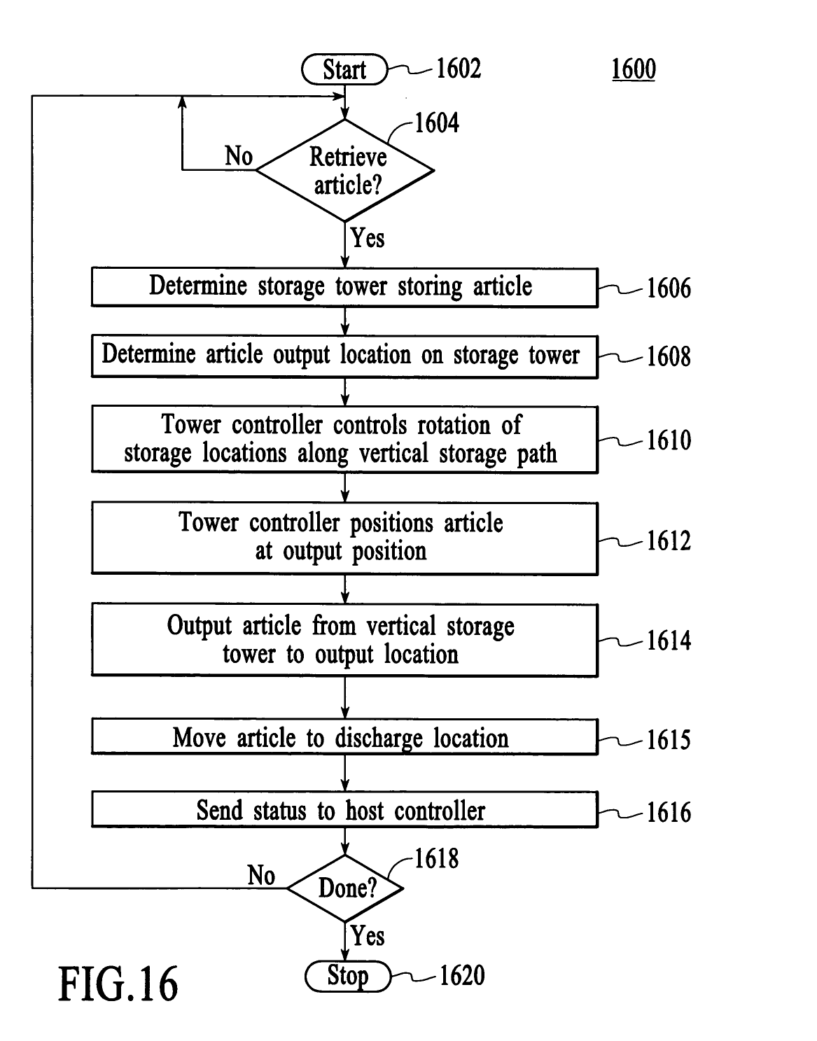

FIG. 16 is a flow diagram of a method 1600 to determine output disposition of articles processed by a vertical storage tower system 100 in accordance with aspects of the invention. Method 1600 may be entered into at 1602 for example by activating an output sequence of vertical storage tower system 100 to output one or more articles 114 therefrom. At 1604, method 1600 determines if an article 114 is to be retrieved from at least one vertical storage tower 102A-N. If an article 114 is not to be retrieved from at least one vertical storage tower 102A-N, then method 1600 continues its output query at 1604. At 1606, if at least one article is to be outputted, then method 1600 determines which vertical storage towers 102A-N are associated with such at least on article 114 and their location. In one embodiment, tower control program 1314 and host control program 1414 may cooperate to determine articles 114 to be retrieved and their movable storage location 108 based on data from respective storage locations data 1316 and 1416. For example, detectors 116, 313 and 314, and position control system 580 may provide input data to tower controller 122A-N to determine identity of articles 114 in movable storage locations 108 associated therewith where one or more articles 114 may have been stored. For example, method 1600 may determine that such articles 114 are to be retrieved from associated vertical storage tower 102B to an output transportation system 112. At 1608, method 1600 determines movable storage location 108 having such one or more articles 114 on vertical storage tower 102B. At 1610, one or more movable storage locations 108 having such one or more articles 114 disposed thereon are rotated along vertical storage path 316, by method 1600. In one configuration, at 1612 a tower controller 122B moves one or more movable storage locations 108, on vertical storage tower 102B, to a predetermined output position. For example, at 1612, method 1600 positions movable storage location 108 having such one or more articles 114 disposed thereon proximate at least one output transportation system 112. At 1614, such one or more articles 114 are transferred from such movable storage location 108 to an output system, such as output transportation system 112. At 1615, method 1600 moves such one or more articles 114 to a discharge location. At 1616, method 1600 communicates a status of such outputted articles to tower controller 122A-N and host controller 120 for example. If at 1618, method 1600 is not finished, method 1600 proceeds to 1604. If however at 1618 method 1600 is finished, method 1600 ends at 1620.

While the foregoing is directed to embodiments of the present invention, other and further embodiments of the invention may be devised without departing from the basic scope thereof, and the scope thereof is determined by the claims that follow.

1. A storage system configured to simultaneously receive, store, and output one or more articles, the storage system comprising:
a plurality of vertical storage towers, each of the plurality of vertical storage towers having a set of movable storage locations associated therewith, each of the sets of movable storage locations being asynchronously movable relative one another along a vertical storage axis, the sets of movable storage locations defining an array of movable storage locations;
an input transportation system positioned proximate the plurality of vertical storage towers along an input axis, the input transportation system configured to receive the one or more articles thereon and position the one or more articles proximate one of the sets of movable storage locations;
an article placement system disposed proximate the input transportation system, the article placement system configured to deliver from the input transportation system the one or more articles thereon to at least one available storage location associated with at least one of the sets of movable storage locations;
an output transportation system disposed proximate the vertical storage towers, along an output axis, the output transportation system configured to receive a stored portion of the one or more articles from the sets of movable storage locations;
an article removal system positioned proximate the output transportation system, the article removal system configured to output a stored portion of the one or more articles from at least one of the sets of movable storage locations to the output transportation system;
a detection system configured to generate signals indicative of a storage status of the array of storage locations, the signals being associated with a disposition of the array of movable storage locations and the one or more articles received by the apparatus; and
a controller electrically coupled to the system and adapted to process the signals therefrom and control the disposition of the one or more articles associated with at least one of the sets of movable storage locations.

2. The storage system of claim 1, wherein the set of movable storage locations define an endless loop.

3. The storage system of claim 2, wherein the input transportation system comprises a conveyor system.

4. The storage system of claim 2, wherein the output transportation system comprises a conveyor system.

5. The storage system of claim 2, wherein the an article placement system comprises a scissor apparatus configured to expand and contract to move the one or more articles from the input transportation system to one or more movable storage locations.

6. The storage system of claim 2, wherein the article removal system comprises a scissor apparatus configured to expand and contract to move one or more stored articles from the sets of movable storage locations to the output transportation system.

7. The storage system of claim 1, wherein the detection system comprises a detector configured to detect an article stored within at least one of the movable storage locations.

8. The storage system of claim 1, wherein the detection system comprises a detector configured to count a number of movable storage locations associated with at least one of the plurality of vertical storage towers.

9. The storage system of claim 1, further comprising a plurality of second controllers, each of the plurality of second controllers configured to control a respective one of the plurality of vertical storage towers.

10. A storage system configured to process articles to be stored, the system comprising:
two or more vertical storage towers aligned along an article processing path defined by an article input path and an article output path;
each of the two or more vertical storage towers include a plurality of storage shelving rotatably suspended between two chains that define an endless loop along a vertical storage path, each of the two or more vertical storage towers being configured to bi-directionally rotate each of the chains associated therewith to position at least some of the plurality of storage shelving proximate the article input path and article output path; and
a plurality of tower controllers, each of the plurality of tower controllers being in control of at least one of the two or more vertical storage towers; each of the plurality of tower controllers comprising:
a memory means containing a tower control program;
a processor means which, when executing the tower control program during an article storing process is configured to:
position along a vertical storage path one of the plurality of storage shelving associated with one of the two or more vertical storage towers proximate an article input position;
move at least one of the articles proximate the article input position from an input transportation system to the one of the plurality of storage shelving to store the at least one article thereon;
the processor means which, when executing the tower control program during an article output process is configured to:
determine a stored article to be retrieved from at least one of the two or more vertical storage towers;
rotate a storage shelving along the vertical storage path to position the stored article to be retrieved relative the article output path;
move the stored article to be retrieved from the storage shelving to an output transportation system for disposition thereof.

11. The storage system of claim 10, further comprising a host controller configured to communicate with at least one of the plurality of tower controllers.

12. A modular and expandable storage system configured to simultaneously and asynchronously receive, store, and output one or more articles, the storage system comprising:
a plurality of modules, each module including:
a set of movable storage locations disposed along a vertical axis, the set of movable storage locations being movable in the vertical axis,
an input transportation segment disposed along a horizontal axis, proximate the set of movable storage locations, the input transportation segment configured to receive and position the one or more articles proximate the set of movable storage locations,
an article placement system disposed proximate the input transportation segment, the article placement system configured to transfer from the input transportation segment, the one or more articles thereon to at least one available storage location associated with the set of movable storage locations,
an output transportation segment disposed along the horizontal axis, proximate the set of movable storage locations, the output transportation segment configured to receive a stored portion of the one or more articles from the set of movable storage locations,
an article removal system disposed proximate the output transportation segment, the article removal system configured to transfer a stored portion of the one or more articles from the set of movable storage locations to the output transportation segment,
a detection system configured to generate one or more signals indicative of a storage status of the set of movable storage locations, the one or more signals being associated with a disposition of the set of movable storage locations and the one or more articles received by the system,
the set of movable storage locations being configured to be movable asynchronously relative the input transportation segment, and the output transportation segment,
the input transportation segment configured to receive and position the one or more articles asynchronously relative the output transportation segment,
a controller electrically coupled to the module and adapted to process the signals therefrom and control the disposition of the one or more articles associated with the set of movable storage locations and
two or more of the plurality of modules defining a two dimensional array of movable storage locations wherein each of the two or more modules operate asynchronously relative one another.

13. The system of claim 12, wherein the set of movable storage locations define an endless loop.

14. The system of claim 13, wherein the endless loop may be moved in a forward and retrograde rotation.

15. The system of claim 12, wherein a first input transportation segment associated with a first module of the two or more modules is configured to communicate articles with a second input transportation segment associated with a second module of the two or more modules.

16. The system of claim 15, wherein a first controller associated with the first module is coupled to asynchronously communicate information with a second controller associated with the second module.

17. The system of claim 16, wherein a host controller is electrically coupled to at least the first controller and the second controller and the host controller is adapted to process signals therefrom and control disposition of the one or more articles to the two or more modules.

18. The system of claim 17, wherein the host controller comprises one of the controllers.

19. The system of claim 12, wherein the article placement system comprises a scissor apparatus configured to expand and contract to move the one or more articles from the input transportation segment to one or more movable storage locations.

20. The system of claim 12, wherein the article removal system comprises a scissor apparatus configured to expand and contract to move one or more stored articles from the set of movable storage locations to the output transportation

21. A method of storing and retrieving articles, the method comprising:
determining at least one available storage location in a storage location array, the storage location array having a first storage axis and a second storage axis, the first storage axis having at least two rows of movable storage locations, the at least two rows of movable storage locations being movable along the second storage axis;
aligning at least one input transportation system along the first storage axis, the input transportation system configured to asynchronously position at least one of the articles relative the at least two rows of movable storage locations;
determining at least one row of movable storage locations containing the at least one available storage location;
positioning the at least one available storage location relative the input transportation system by asynchronously moving the at least one row of movable storage locations containing the at least one available storage location along the second axis;
receiving the at least one article on the input transportation system;
positioning the at least one article asynchronously in the first axis relative the at least one row of movable storage locations having the at least one available storage location;
transferring the at least one article to the at least one available storage location;
aligning at least one output transportation system along the first storage axis, the output transportation system configured to receive at least some articles from the at least two rows of movable storage locations and transport the at least some articles to at least one discharge position;
determining at least one article to be retrieved from any storage location having one or more of the articles stored therein;
determining a row of movable storage locations containing at least one of the articles;
positioning the at least one of the articles relative the output transportation system by asynchronously moving the at least one row of movable storage locations containing the at least one of the articles along the second axis;
transferring the at least one of the articles from the row of movable storage locations to the output transportation system; and
transporting the at least one of the articles on the output transportation system to the at least one discharge position.

22. The method of claim 21, further comprising identifying the article to be stored by:
scanning a barcode attached to the article to be stored and
communicating the barcode number to a host controller.

23. The method of claim 21 further comprising identifying the article to be stored by detecting machine-readable labels wherein the machine-readable labels comprise one-dimensional bar-codes, two-dimensional bar-codes, memory buttons, smart cards, radio-frequency identifier tags (RFID), smart cards, magnetic stripes, micro-chip transponders, and combinations thereof.

24. The method of claim 21, wherein the vertical shelves may be indexed in a forward or retrograde rotation.

25. The method of claim 21, further comprising detecting the presence of the article to be stored at a position relative the at least one row of movable storage locations having the at least one available storage location, with a proximity sensor.

26. The method of claim 25, further comprising deploying a fence to physically prevent the article to be stored from being transported by the input transportation system beyond the position relative the at least one row of movable storage locations having the at least one available storage location.

27. The method of claim 25, further comprising deploying a fence to physically prevent the article to be stored from being transported by the output transportation system.

28. The method of claim 21, further comprising independently controlling the at least two rows of movable storage locations with a local controller associated with each of the at least two rows of movable storage locations;
communicating information between the controller and at least one other local controller controlling another row of movable storage locations and
communicating information between the local controllers and a host controller.

29. The method of claim 28, further comprising controlling a segment of the input transportation system adjacent a row of movable storage locations with the local controller associated with the row of movable storage locations.

30. The method of claim 28, further comprising controlling a segment of the output transportation system adjacent a row of movable storage locations with the local controller associated with the row of movable storage locations.

31. A method of asynchronously transporting at least one article from an input location to an output location, the method comprising:
determining at least one available storage location from two or more independent sets of storage locations rotatably aligned along a first axis, each of the two or more independent sets of storage locations being movable along a storage axis;
aligning an input transportation system along the first axis relative the two or more independent sets of storage locations,
forming at least one article input position by asynchronously moving the at least one available storage location along the storage axis until the at least one available storage location is aligned with the input transportation system in an article receiving position;
transporting at least one of the articles asynchronously from the input location along the input transportation system and aligning the at least one of the articles proximate the at least one article input position;
inserting the at least one article into the at least one available storage location;
aligning an output transportation system along the first axis relative the two or more independent sets of storage locations,
forming at least one article output opening by asynchronously rotating the at least one storage location with an article to be extracted therefrom along the storage axis until the at least one storage location is aligned with the output transportation system in an article extraction position;
extracting the article to be extracted from the at least one storage location onto the output transportation system; and
transporting the article to be extracted on the output transportation system to the output location.

32. The method of claim 31, further comprising identifying the at least one article by:
scanning a barcode attached to the article to be stored and
communicating the barcode number to a host controller.

33. The method of claim 31 further comprising identifying the at least one article by detecting machine-readable labels wherein the machine-readable labels comprise one-dimensional bar-codes, two-dimensional bar-codes, memory buttons, smart cards, radio-frequency identifier tags (RFID), smart cards, magnetic stripes, micro-chip transponders, and combinations thereof.

34. The method of claim 31, wherein the sets of storage locations may be rotated in a forward and retrograde rotation.

35. The method of claim 31, further comprising detecting the presence of the at least one article proximate the at least one article input position, with a, with a proximity sensor.

36. The method of claim 35, further comprising deploying a fence to physically prevent the at least one article from being transported by the input transportation system beyond the at least one article input position.

37. The method of claim 35, further comprising deploying a fence to physically prevent the at least one article from being transported by the output transportation system.

38. The method of claim 31, further comprising independently controlling at least one of the two or more independent sets of storage locations with a local controller;
communicating information between the local controller and at least one other local controller
communicating information between the local controller and a host controller.

39. The method of claim 38, further comprising controlling a segment of the input transportation system adjacent the at least one of the two or more independent sets of storage locations, with the local controller.

40. The method of claim 38, further comprising controlling a segment of the output transportation system adjacent the at least one of the two or more independent sets of storage locations, with the local controller.
